(19) United States
(12) Patent Application Publication
(10) Pub. No.: US 2004/0010349 A1
(43) Pub. Date: Jan. 15, 2004

(54) Device and method for monitoring a genset using a controller area network bus interface

(76) Inventors: Larry Perez, Breese, IL (US); Bruce Allen, Alhambra, IL (US); Fabio Compare, Carlyle, IL (US); Doug Malone, Lebanon, IL (US); Miguel Rodriguez, Austin, TX (US)

Correspondence Address: THOMPSON COBURN, LLP, ONE US BANK PLAZA, SUITE 3500, ST LOUIS, MO, 63101, US

(21) Appl. No.: 10/194,695

(22) Filed: Jul. 12, 2002

(51) Int. Cl. G05D 3/12

(52) U.S. Cl. 700/287

(57) ABSTRACT

A genset monitoring and control device that interactively monitors and can control a genset having an internal network over which engine data is communicated is implemented with a network interface for coupling with the genset's internal network to receive engine data therefrom and pass data and commands thereover. The genset monitoring and control device's processor uses the engine data received directly from the genset's internal network via the network interface to control and monitor the operation of the genset. Also, the genset monitoring and control device can request various engine data from the genset's internal network, and command new data to be collected in response to a command. The internal network is preferably a controller area network (CAN), and the engine data is preferably communicated on the CAN in the SAE J1939 messaging protocol.

### FIELD OF INVENTION

The present invention relates to the field of devices that monitor and control the operation of engine-driven generator sets, referred to herein as “genset(s)”.

### BACKGROUND OF THE INVENTION

Genset monitoring and control devices are known in the art to perform such tasks as crank control, voltage metering, frequency metering, current metering, coolant temperature metering, coolant temperature protection, oil pressure metering, oil pressure protection, fuel level sensing, fuel leak detection, cool down, watt metering, VA metering, RPM metering, power factor metering, watt-hour metering, run time metering, battery voltage metering, battery condition monitoring, maintenance monitoring, overload protection, low coolant level detection, battery charger failure monitoring, and diagnostic reporting etc. Traditionally, to monitor and control such aspects of genset operation, the monitoring and control device utilized various sensing circuits and external transducers, many of them analog, that coupled with appropriate outputs of the genset to obtain the genset data necessary to perform its monitoring and control tasks. Such sensing circuits condition, filter, and digitize the data they receive from their respective transducers, and then pass that data on to a microprocessor that is programmed to use such data in monitoring and controlling the operation of the genset. However, this technique suffers from drawbacks relating to the difficulty of wiring the genset monitoring and control devices to the various external transducers situated at different locations on the genset.

Today, many gensets use an internal network known as a controller area network (CAN) to communicate engine data from the genset's engine control module (ECM) to various genset monitoring and control devices for proper control of the genset. FIG. 1 illustrates an overview of how a CAN works for a given genset 100. CAN was originally developed in the automotive industry. However, in recent years, CAN technology has migrated into the field of engines used in other applications. With CAN, engine data that is indicative of how the engine is operating is broadcast by the ECM 102 on a CAN bus that connects the ECM with the various genset monitoring and control devices. The engine data is communicated on the CAN bus 104 in a standardized format. The generator data broadcast on the CAN Bus by the ECM includes various parameters such as battery voltage, coolant level, coolant temperature, crank case pressure, engine hours, RPM, turbo boost pressure, amount of fuel consumed, fuel delivery pressure, fuel filter differential pressure, fuel consumption rate, oil filter differential pressure, oil pressure, oil temperature and percent generator load. Additionally, the engine data transmitted on the CAN bus may include three digit codes known as diagnostic trouble codes (DTCs). Each DTC is indicative of a problematic condition of the engine sensed by the ECM.

Dissatisfied with traditional genset monitoring and control device's use of a multitude of analog sensors and transducers, as well as the complexity, cost, and additional maintenance hassles involved in wiring to external transducers, the inventors herein have sought to design a genset monitoring and control device capable of monitoring and controlling the operation of a genset with minimal extra hardware components. Toward this end, the inventors have designed a genset monitoring and control device which interfaces directly with the genset's CAN bus to directly receive the engine data broadcast by the ECM thereon. In doing so, the need for wiring to external transducers is eliminated. Also since the engine data will be measured directly from the ECM, any incompatibility issues that may have existed between engine data sensed by the ECM and engine data sensed by the various analog sensors and transducers will be eliminated. Further, by directly sensing the engine data from the ECM, metering accuracy is increased.

The inventors have also extended the functionality of the ECM by adding the capability to power up the ECM, obtain data on demand and in real time, and even start up the genset with their invention of the genset monitoring and control device. Further, by using appropriate software, the genset monitoring and control device may be controlled by a PC through any appropriately configured data link including especially a wireless link. With this capability, a user is able to not only passively and remotely monitor the ECM to read the data it would ordinarily collect on its own schedule but also actively collect data on demand, turn the genset on, and perform virtually any operation remotely. The remote operation feature is especially important for applications such as remote cell phone towers, repeater stations, and other applications requiring electrical power at remote locations, where local utility power is not yet available.

### SUMMARY OF THE INVENTION

Accordingly, disclosed herein is a device for interactively monitoring and controlling the operation of a genset having an internal network over which engine data is communicated, the device comprising: a network interface for coupling with the internal network for receiving and transmitting engine data, and a processor in communication with the network interface that is configured to process the received engine data to thereby monitor and control the operation of the genset, activate the ECM for data collection activity, and transmit genset operation commands. Preferably, the internal network is a controller area network (CAN) and the genset includes a CAN bus on which the engine data is communicated. The device's network interface is preferably a CAN receiver that couples with the CAN bus to receive the engine data. Also, if the engine data is communicated on the CAN bus as message frames formatted according to the J1939 protocol, the processor is configured with a software module operable to extract genset data from the J1939 message frames and process that extracted engine data to thereby monitor and control the operation of the genset.

Preferably, the engine data comprises a value for an engine parameter, the engine parameter being any of the group consisting of battery voltage, coolant level, coolant temperature, crank case pressure, engine hours, revolutions per minute (RPMs), turbo boost pressure, fuel consumption, fuel delivery pressure, fuel filter differential pressure, fuel consumption rate, oil filter differential pressure, oil pressure, oil temperature and percent engine load. Also, the engine data may further comprise at least one diagnostic trouble code (DTC), each DTC being indicative of a problematic condition of the engine.

Also, the device may further comprise a display in communication with the processor, wherein the processor is also configured to provide at least a portion of the extracted engine data to the display for display thereon. Further still, the device may further comprise at least one input in communication with the processor through which a user can select at least one engine parameter value to be displayed, wherein the processor is also configured to provide the selected engine parameter to the display for display thereon.

Moreover, the processor may be configured to communicate engine data received from the CAN (such as DTCs), data requests to the ECM, and engine commands between it and a remote device via a communications port (such as an RS232 transceiver). The remote device may encompass such devices as a general purpose computer, PC, or a telephone pager.

Further still, the processor can be configured to have the ability to process the extracted engine parameter values to determine whether an alarm condition exists or whether a pre-alarm condition exists within the engine. Toward this end, the processor may store a plurality of threshold alarm values therein, each threshold alarm value having a corresponding engine parameter, and wherein the processor is further configured to (1) determine whether an alarm condition exists by comparing an extracted value for an engine parameter with that engine parameter's corresponding stored threshold alarm value, and (2) if an alarm condition is determined to exist, provide a signal to the display that is operative to indicate the existence of the determined alarm condition. Further still the processor may also store a plurality of threshold pre-alarm values therein, each threshold pre-alarm value having a corresponding engine parameter, and wherein the processor is further configured to (1) determine whether a pre-alarm condition exists by comparing an extracted value for an engine parameter with that engine parameter's corresponding stored threshold pre-alarm value, and (2) if a pre-alarm condition is determined to exist, provide a signal to the display operative to indicate the existence of the determined pre-alarm condition.

In addition to receiving unsolicited messages broadcast on the CAN, the genset monitoring and control device of the present invention may also transmit requests for engine data over the CAN to the ECM. In such instances the CAN receiver is a CAN transceiver. The processor will issue a request message to the CAN transceiver that is broadcast over the CAN to the ECM. Once in receipt of the request for engine data, the ECM responds by broadcasting the requested data. This data may be either engine parameter values or DTCs. In some instances, the genset may even be turned on or powered up in response to commands received from the genset monitoring and control device and the data then collected after the genset is run. Preferably, there is software installed on a PC which allows the user at the PC to interactively control the genset for data collection or even running needs.

By eliminating the need for additional analog sensors and transducers to detect, engine data, the present invention provides an efficient means for receiving engine data directly from the genset's ECM. Not only does this save the costs associated with incorporating a multitude of additional sensors and transducers into the genset monitoring and control device, but also improves the accuracy of the sensed data by eliminating any inconsistencies between the engine data broadcast by the ECM and the engine data that would have been sensed by the analog sensors and transducers.

Also, by accessing the DTCs communicated on the CAN bus, the present invention allows technicians to obtain diagnostic data that is highly useful in servicing the genset. Further, by communicating the DTCs to a remote device, such as a technician's computer or pager, the present invention allows technicians to identify engine problems before traveling to the genset's location, to thereby improve the technician's efficiency because the technician is enabled to arrive at the genset's site with knowledge of the problem and the tools necessary to correct the problem.

The interactive feature permits efficient remote operation and monitoring over communication links, enabling a user to more reliably monitor any genset and be assured that it is operating properly.

These and other advantages of the present invention will be in part apparent and in part pointed out hereinafter in the following description and figures.

### BRIEF DESCRIPTION OF THE DRAWINGS

FIG. 1 illustrates a typical controller area network topology;

FIG. 2 illustrates a genset monitoring and control device interfaced with a CAN bus in accordance with the present invention;

FIG. 3 illustrates a block diagram overview of the genset monitoring and control device of the present invention;

FIG. 4 illustrates the CAN transceiver and isolation circuit of the present invention;

FIG. 5 depicts a preferred user interface panel for the genset monitoring and control device of the present invention;

FIG. 6(a) depicts a CAN message frame;

FIG. 6(b) depicts the arbitration field of a J1939 frame;

FIG. 7 depicts the 5 layer model for the J1939 protocol used with the present invention;

FIG. 8 illustrates the software module of the present invention for receiving and processing CAN data;

FIG. 9 is an overview of data flow between the submodules shown in FIG. 7;

FIG. 10 is a table of parameter group numbers (PGNs) supported by the present invention;

FIG. 11 is a table identifying the engine data found in the data fields of message frames for particular PGNs;

FIG. 12 is a detailed overview of data flow between the various layers of the J1939 submodule;

FIGS. 13(a) and 13(b) show bit timing data for the CAN transceiver;

FIG. 14 is a diagram illustrating how layers 4 and 5 of the J1939 submodule separate;

FIG. 15 is a data array of message names for transmit messages;

FIG. 16 shows an example of the transmit message queue (TxMQ);

FIG. 17 is a data array of message types;

FIG. 18 is a data array associating each transmit message name with a message type;

FIG. 19 is a data array of parameter group names;

FIG. 20 is a data array associating each transmit message name with a parameter group name;

FIG. 21 is a data array identifying the information to be associated with each parameter group;

FIGS. 22(a) and 22(b) illustrate the parameter description table;

FIG. 23 is a data array listing the types of message transmissions on the CAN bus;

FIG. 24 is data array of timeout counter names;

FIG. 25 is a data array that associates each timeout counter name with a particular counter;

FIG. 26 is a data array associating each timeout counter name with a timeout value;

FIG. 27 is a data array associating each timeout counter name with a failsoft function;

FIG. 28 is a data structure that identifies the values of each generator parameter;

FIG. 29 is a data structure that identifies whether a new value for an engine parameter has been stored in the data structure of FIG. 27; and

FIG. 30 is a data structure that identifies whether a failure has occurred in obtaining a value for an engine parameter.

### DETAILED DESCRIPTION OF THE PREFERRED EMBODIMENT

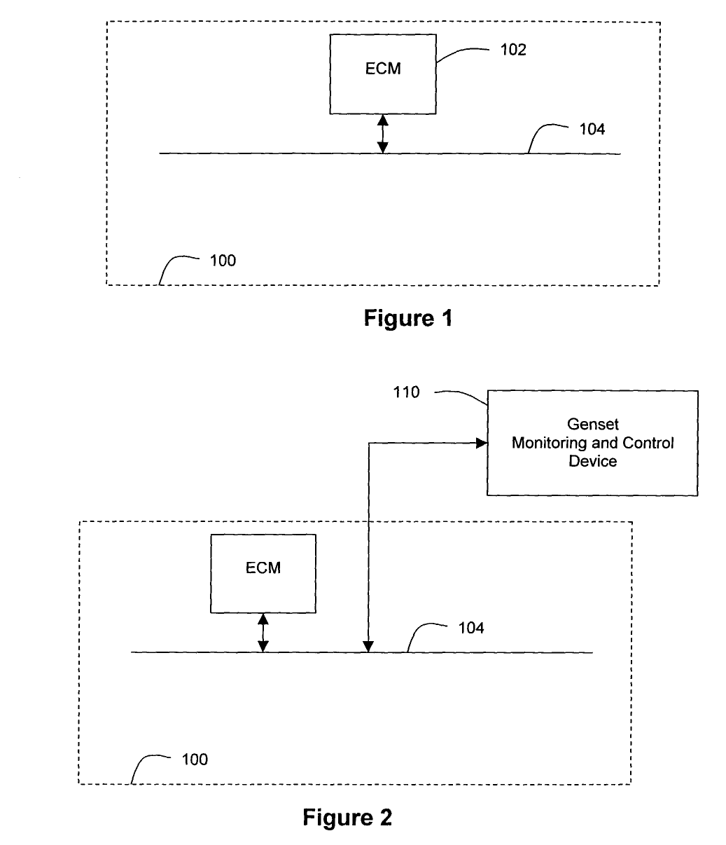

FIG. 2 illustrates how a genset monitoring and control device 110 interfaces with a genset 100 in accordance with the present invention. The monitoring and control device 110 couples with the engine's CAN bus 104. Through this coupling, the monitoring and control device is not only able to receive the engine data that is broadcast thereon, but also broadcast various requests for engine data and operation commands to the engine itself. In addition to the CAN bus interface, the genset may also have additional sensing devices to obtain other forms of engine/generator data. However, as such interfaces are well known in the art, they need not be shown in FIG. 2.

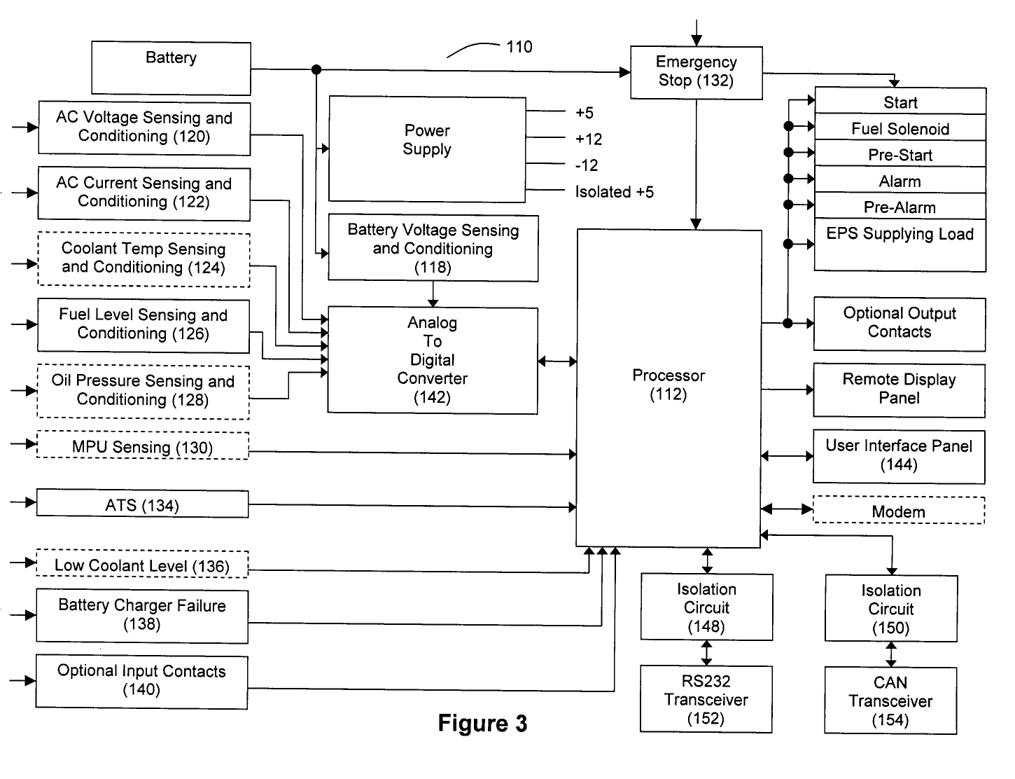

FIG. 3 illustrates an overview of the genset monitoring and control device 110 of the present invention. Processor 112 receives genset data from various peripheral inputs and processes that data to make determinations reflective of how the genset is operating. Preferably there are eight types of inputs to the genset monitoring and control device 110: Operating (battery) DC power, contact sensing, sending units, front panel operator controls, voltage sensing, current sensing, serial communications via a RS232 port and CAN communications via a CAN bus interface. More or fewer input types may be implemented in connection with the present invention depending upon how the device 110 is being used, as would be apparent to one of ordinary skill in the art.

The internal power supply circuit supplies power to all circuitry within the genset monitoring and control device. Required operating voltage is a nominal 12 or 24 Vdc. Operating voltage may be in the range of 8 to 32 Vdc. The switching power supply uses the battery voltage to generate a +12 Vdc, −12 Vdc, +5 Vdc, a stable +5 Vdc reference, and an isolated +5 Vdc. The isolated +5 Vdc supply is for the RS232 serial communications transceiver 152. The DC reference voltage is for internal use. The battery operating voltage is also conditioned (filtered and reduced to a level suitable for processor input) and sensed by the microprocessor.

Four external contact sensing inputs (emergency stop, automatic transfer switch (ATS), low coolant level and battery charger failure) provide external stimulus to the processor 112. The emergency stop input 132 is continually monitored by the processor 112. An open circuit indicates that an emergency stop condition exists. An open circuit on the emergency stop input 130 removes power from all output relays. The ATS input 134 is also continually monitored by the processor 112. It is used to start the engine when in the auto mode. A closed contact on the ATS input 134 indicates that a start sequence is to begin. Low coolant level input 136 is also continually monitored by the processor 112. When the battery (−) potential is connected to the low coolant level input 136, a low coolant level is indicated to the processor 112. In FIG. 3, the low coolant level input 136 is shown in dashed lines to indicate that it is an optional feature of the device 110. Because low coolant data can be obtained from the genset's CAN bus, the processor 112 can receive this information via the CAN transceiver 154 (by way of isolation circuit 150) rather than using the separate low coolant level input 136. The battery charger failure input 138 is also continually monitored by the processor 112. When the battery (−) potential is connected to this input, a battery charger failure is indicated to the processor 112.

The transducer inputs 120-130 for the device are programmable. This gives users the flexibility to choose the transducer to be used in a particular application. To account for differences between transducers, adjustments can be made using software executed on a peripheral device such as a PC in communication with the processor 112 to modify the processor's calculations. An analog-to-digital converter 142 is used to digitize the data sensed by the various transducers and pass the digitized data to the processor 112.

Coolant temperature sensing and conditioning transducer 124 is used to determine the temperature of the coolant in the engine. Preferably, a current of less than 20 milliamperes is provided to the coolant temperature transducer 124. The developed voltage is measured and scaled for use by the internal circuitry, and the coolant temperature determined thereby. Coolant temperature transducer 124 is also shown in dashed lines to indicate that it is an optional feature of the present invention. The processor 112 can receive coolant temperature data through the CAN transceiver 154. Fuel level sensing and conditioning transducer 126 is also an optional feature of the present invention. The fuel level and fuel leak transducers are used to provide data to the processor 112 reflective of the fuel level for the genset and whether a fuel leak condition exists. Oil pressure sensing and conditioning transducer 128 is also an optional feature of the present invention. This transducer is operable to provide the processor 112 with the data necessary to determine the oil pressure within the engine.

The speed signal inputs are the AC voltage sensing and conditioning transducer 120 and the magnetic pickup unit (MPU) 130. Data coming from these transducers may be used by the processor to identify the genset's speed. The MPU 120 is shown in dashed lines to indicate that it is an optional input of the invention (because the CAN transceiver 154 may also be used to obtain such data).

Monitored generator voltages that are sensed by the AC voltage transducer 120 are scaled to levels suitable for use by the internal circuitry. Resistor networks provide additional scaling and isolation for these inputs. Internal circuitry selects line to line, line to neutral, or single phase sensing configurations. Via the user interface panel 144, a user may provide input to the processor 112 corresponding to a selection of the switch settings that are displayed on a menu shown on the user interface panel 144. Also, the AC current sensing and conditioning transducer 122 senses a generator's current and scales its sensed values to a suitable level for use by the internal circuitry. Internal current transformers provide isolation. Two taps on the primary of these transformers accommodate either one or five ampere circuits.

Further, for serial communications with a peripheral device (such as a remote computer or telephone pager), an RS232 transceiver 152 may be used to interface the processor 112 with the peripheral device. Also, a modem may optionally be used (as indicated by the dashed box surrounding the modem). An isolation circuit 148 interfaces the processor 112 with the RS232 transceiver 152. The peripheral device can run software that allows a user, by way of the RS232 transceiver 152, to remotely monitor or alter the programming resident on the processor 112. The peripheral device is preferably a PC which is programmed with software such as that shown in flow charts attached as exhibit A. This software provides full interconnectivity between the PC and the genset monitoring and control device to allow a remote user full control and monitoring capabilities.

The circuitry design for the inputs 118 through 142 are all well known in the art and are quite often standard features on genset monitoring and control devices. As such, one of ordinary skill in the art would readily be able to implement any of a wide variety of such inputs and interface those inputs with a processor 112. The processor 112 is preferably a Motorola MC68HC912DG128 16 bit microcontroller. However, other processors may be readily used as would be understood by those of ordinary skill in the art. Also, although it has been shown that various inputs may be optional features of the present invention (as indicated by the dashed lines), the present invention may also utilize all shown inputs to thereby make the device 110 a universal device. While many gensets that use CAN are now available using the internal network known as the CAN, some gensets do not have this feature. In such instances, traditional transducers will be needed to detect the data that could otherwise be detected using a CAN bus interface. Thus, for the device of the present invention to be universal (that is, for the device to be useful in connection with all gensets whether or not they utilize a CAN) the present invention may utilize both a CAN interface and separate transducer inputs. However, as time passes and CAN further infiltrates the genset market, the use of separate transducers that render the device universal can be expected to fade out.

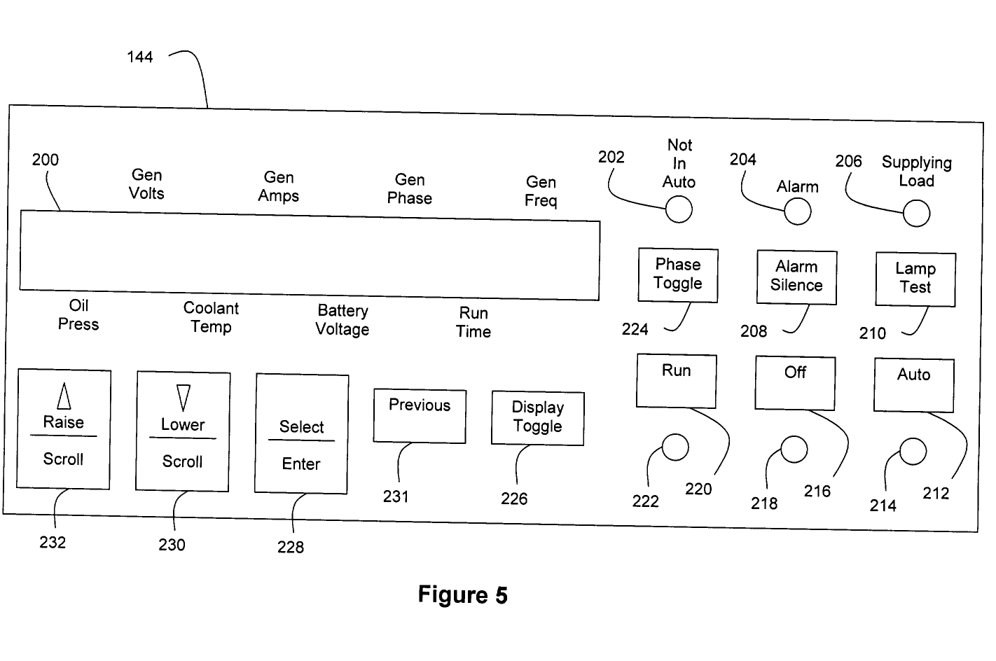

FIG. 5 illustrates the user interface panel 144 for the monitoring device 110. Display 200 is preferably a two line by twenty character LCD that provides the primary visual interface for metering, alarms, pre-alarms, and protective functions. LED 202 is preferably a red LED that is activated when the monitoring device is in not in the auto mode. LED 204 is preferably a red LED that is continuously activated during all alarm conditions and intermittently activated for pre-alarm conditions. LED 206 is preferably a green LED that is activated when the generator is supplying more than 2% of the rated current. Pushbutton 208 is operable to silence the audible alarm feature. Pushbutton 210 is operable to exercise all segments of the LCD and illuminate all of the LEDs. Pushbutton 212 is operable to place the monitoring device in auto mode. Led 214 is preferably a green LED activated when the monitoring device is in the auto mode. Pushbutton 216 is operable to place the monitoring device in the off mode. LED 218 is preferably a red LED that is illuminated when the monitoring device is in the off mode. Pushbutton 220 is operable to place the monitoring device in the run mode. LED 222 is preferably a green LED illuminated when the monitoring device is in the run mode. Pushbutton 224 is operable to scroll through menu display screens that are available in a normal display mode. Pushbutton 226 is operable to scroll through the various display modes. Pushbutton 228 is operable to enter menu sublevels and select set points for values such as the programmable threshold alarm and pre-alarm values (which are explained below). Pushbutton 230 is operable to scroll backward through the menus and decrement set points, and pushbutton 232 is operable to scroll forward through the menus and increment set points. Pushbutton 231 is operable to display the immediate preceding menu. By appropriately cycling through the various menus available for display, a user can reset the front panel programmable settings stored by the processor 112.

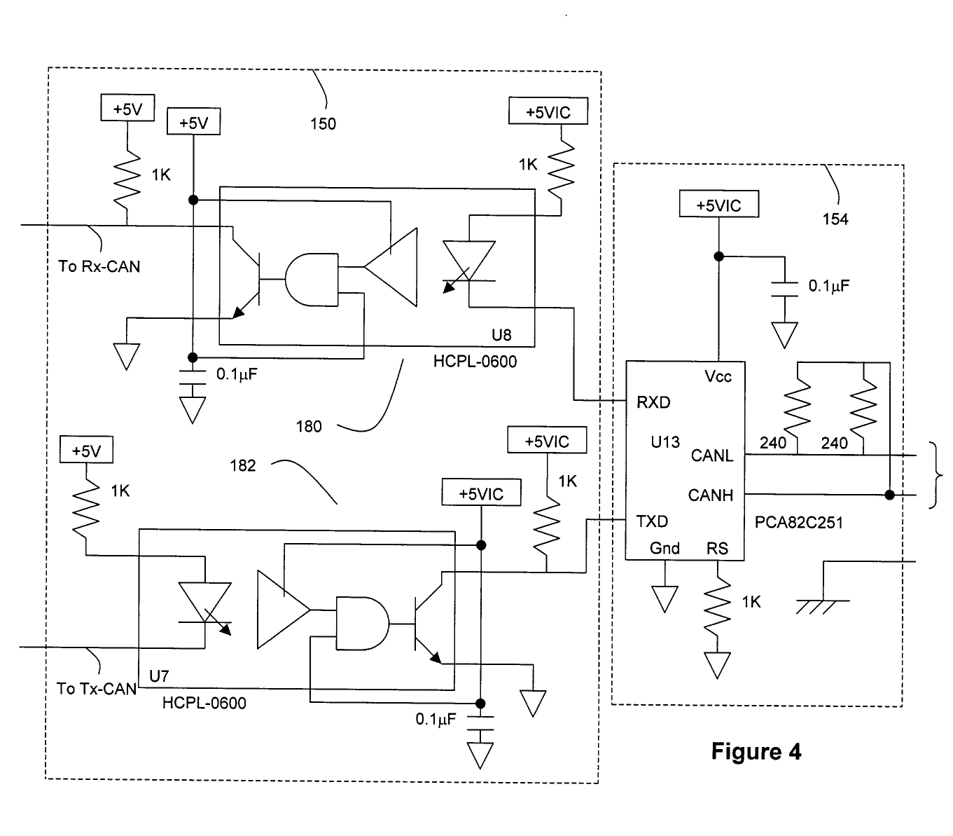

The CAN transceiver 154 interfaces the processor 112 with the CAN bus of the generator (by way of isolation circuit 150). FIG. 4 illustrates the CAN transceiver 154 and isolation circuit 150. The CAN transceiver is preferably a PCA82C251 CAN transceiver manufactured by Philips Semiconductors of Eindhoven, Netherlands with CAN low and CAN high inputs as shown. Isolation circuit 150 preferably includes a receive path component 180 and a transmit path component 182 as shown.

The CAN protocol is an ISO standard (ISO 11898) for serial data communication. The CAN standard defines several different message types, arbitration rules for access to the CAN bus, and methods for fault detection and fault confinement. The physical layer uses differential transmission on a twisted wire pair. Non-destructive bit-wise arbitration is used to control access to the bus. Message frames are relatively small in length (the data field is at most 8 bytes in length), and an error handling scheme provides both message retransmission in certain circumstances as well as fault isolation.

As shown in FIGS. 1 and 2, the CAN bus 104 is a shared broadcast bus which runs at speeds up to 1 Mbit/sec. Message frames are communicated on the CAN bus among various nodes connected thereto. The message frames are variable in length—the data field of a message frame may range from 0 to 8 bytes. Also, each message frame includes an arbitration field that serves to uniquely identify the message. Message frames are primarily identified by function rather than a physical destination. That is, rather than addressing a message to a particular node on the network by uniquely identifying that particular node in the arbitration field of the message frame, the arbitration field of the message frame identifies the functional content of the data field. All nodes on the CAN bus will receive the message frame and determine from the arbitration field whether the data contained in the message is of interest.

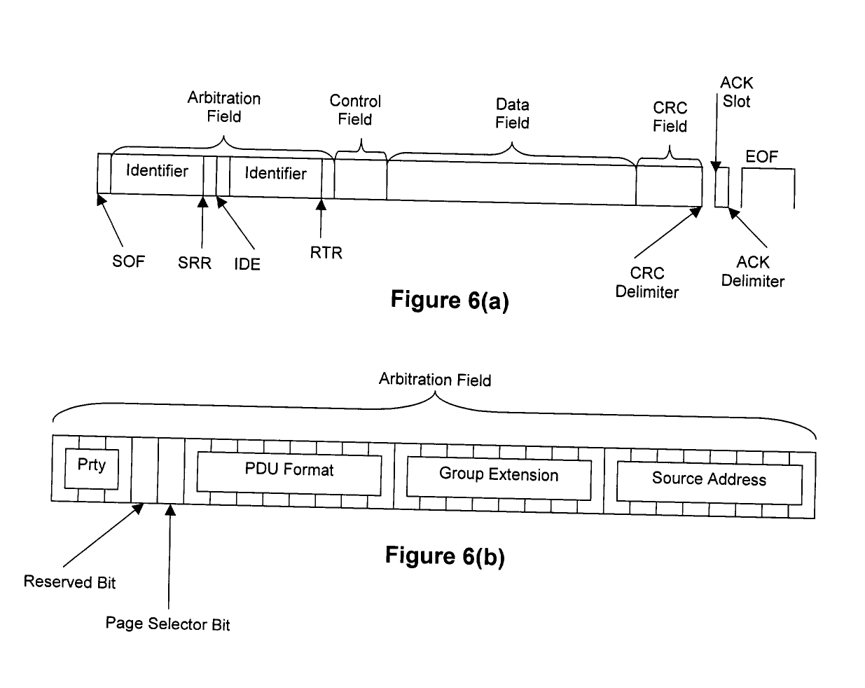

FIG. 6(a) illustrates an exemplary CAN message frame. The arbitration field is 32 bits, 29 bits of an identifier field, an SRR bit, IDE bit and an RTR bit. The 29 bit identifier field serves to uniquely identify the functional content of the variable length data field. The CRC field contains a 15 bit checksum calculated on most portions of the message that is useful for error detection purposes. Each message frame also includes an acknowledgment (ACK) slot. Any node on the CAN bus that correctly receives the message frame sends an acknowledgment bit at the end of each message frame. The sending node checks for the presence of an acknowledgment bit in the ACK slot and will retransmit the message frame if no acknowledgment bit is detected. Thus, when an acknowledgment bit is detected, the sending node will know that at least one node in the CAN bus has received the message, but will not know which particular node received the message frame.

FIG. 6(b) shows the layout for the arbitration field of a J1939 message frame. The SOF, SRR, IDE, and RTR bits will be ignored. The first 3 bits form the priority field. The priority field may be set independently of other message fields, and the CAN protocol uses the priority field of each message frame to arbitrate bus access when two or more nodes are simultaneously competing for bus access. The fourth bit is a reserved bit that has been reserved for use in connection with future developments of J1939. The fifth bit is a page selector wherein page 0 includes currently defined J1939 messages and page 1 is reserved for future additional J1939 messages. Thus, for the present invention, the page selector bit will be 0. The next 8 bits are the Protocol Data Unit (PDU) format field. The PDU format field identifies what type of PDU the message is. If the value of the PDU field is 240 or greater, then the PDU format is type 2. Otherwise, it is type 1. The next 8 bits are PDU type specific. If the PDU type is type 1, the next 8 bits are a destination address. If the PDU type is 2, the next 8 bits contain an extended data content group extension. Most messages transmitted in connection with the present invention will be type 2 messages. For type 2 messages, the page selector bit PDU format field, and group extension field serve as a parameter group number (PGN) that uniquely identifies the message frame. For type 1 messages, the page selection bit and PDU format field form the PGN. The final 8 bits of the identifier contain the address of the sending node.

The CAN protocol itself only specifies how small frames of data may be safely transmitted from point A to point B via a shared bus. It does not address higher level topics such as flow control, large data transmissions (>8 bytes), message layout within fields and error handling routines based on higher level errors. To address these needs, a higher layer protocol (HLP) is needed. Although a variety of HLPs exist and may be used in the practice of the present invention, the preferred HLP is SAE J1939. A wealth of information is available in the art that addresses the SAE J1939 protocol. For such details, see the following SAE publications: “SAE J1939: Recommended Practice for a Serial Control and Communications Vehicle Network”; “SAE J1939/11: Physical Layer”; “SAE J1939/13: Off Board Diagnostic Connector”; “SAE J1939/21: Data Link Layer”: “SAE J1939/31: Network Layer”: “SAE J1939/71: Vehicle Application Layer”: “SAE J1939/73: Application Layer-Diagnostics”; and “SAE J1939/81: Network Management”, the entire disclosures of all of which are incorporated herein by reference.

The J1939 message frame includes an identifier which defines the message's priority, who sent it, and what data is contained therein. Bus collisions are avoided due to the arbitration process that occurs while the identifier is transmitted.

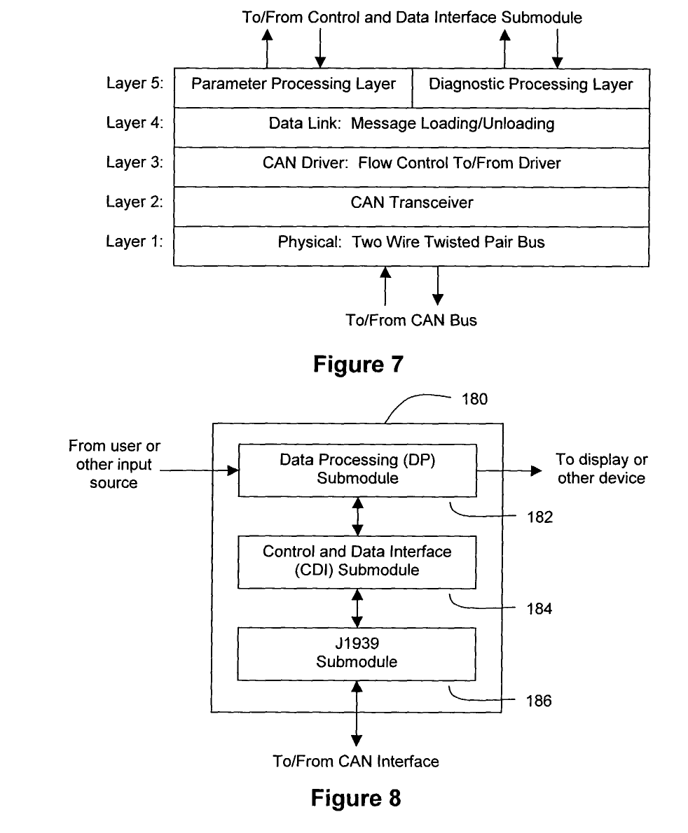

The J1939 protocol is structured in 5 layers, which provides for modular development and is somewhat in keeping with the ISO-OSI 7-layer model for Communications Networks. FIG. 7 illustrates the 5 layer model for the J1939 protocol. Layer 1 is the physical layer. It represents the communication media interconnecting devices with the CAN bus. For CAN, the physical layer is typically a two wire twisted pair bus. Layer 2 is the hardware device that provides the interface between the CAN bus and the monitoring device's processor—which, for the present invention, is the CAN transceiver 154. Layer 3 is the software that provides flow control to and from the CAN transceiver. The layer 3 software is typically specific to the type of CAN transceiver used. Layer 4 is the data link layer. Layer 4 is software that provides for message loading/unloading and manages the specific messages to be transmitted or received via the data link. Message filtering and network health monitoring are also performed by this layer. Layer 5 is the application layer. It contains the processing for the engine parameters (see Part 71 of the SAE J1939 protocol) and the diagnostic data—DTCs, DTC clears, etc.-(see Part 73 of the SAE J1939 protocol).

By processing each frame's PGN, the software of the present invention is able to determine the functional content of each message frame's data field to thereby determine whether a particular message frame is of interest to the genset monitoring and control device.

FIG. 8 illustrates a software module 180 resident on the processor 112 that carries out the monitoring tasks for the device 110 in connection with the CAN bus interface. The software module 180 is divided into three main submodules: a data processing submodule 182 that carries out the high level data processing used to determine how the engine is operating as well as make decisions therefrom, a J1939 submodule 186 that is the primary interface for handling messages formatted according to the J1939 protocol (for messages arriving from the CAN bus, the J1939 submodule operates to extract engine data from received messages; for outbound traffic, the J1939 subsystem operates to create message frames according to the CAN/J1939 protocol), and a control and data interface (CDI) submodule 184 that is used to pass variables between the data processing submodule 182 and the J1939 submodule 186.

Among the tasks that the DP submodule carries out with respect to the extracted engine data are pre-alarm monitoring and alarm monitoring. An alarm condition indicates that a problematic condition exists within the engine that is of sufficient severity to shut down the engine. When the data processing (DP) submodule of the processor detects the existence of an alarm condition, that alarm condition will be displayed via a suitable output (e.g., the user interface panel's 144 LCD 200, an audible alarm warning, an LED lamp, etc,). Further, the processor may be configured to communicate the alarm condition to a remote device via the RS232 interface. Also, each alarm will have a common Form A contact. When the alarm condition is detected, the Form A contact is closed and the fuel solenoid contact opens to thereby shut down the engine. Preferably, an alarm reset may only be done locally by setting the appropriate switch on the device's user interface panel 144.

The DP submodule will store programmable threshold alarm values that correspond to each genset parameter. If the genset parameter value received by the DP submodule from the CDI submodule is outside the limits set by the threshold alarm value corresponding to that genset parameter, then the DP submodule will conclude that an alarm condition exists. Additionally, each threshold alarm value may be accompanied by a programmable delay time, in which case the DP submodule will not conclude that an alarm condition exists until the received genset parameter remains outside the limit set by the threshold alarm value for the duration of the delay time.

A pre-alarm condition indicates that a problematic condition exists within the genset, but that problem is not so severe as to require a genset shutdown. For example, if a particular genset parameter is becoming uncomfortably close to its threshold alarm value, a pre-alarm condition may exist. When the DP submodule detects the existence of a pre-alarm condition, it preferably will display the cause of the pre-alarm on the user interface panel 144 LCD 200. Also, the DP submodule may initiate an audible pre-alarm warning. Further, the DP submodule may be configured to communicate the pre-alarm condition to a remote device via the RS232 interface. Preferably, a pre-alarm is reset by correcting the cause of the prealarm.

The DP submodule will store programmable threshold pre-alarm values that correspond to each genset parameter. If the genset parameter value received by the DP submodule from the CDI submodule is outside the limits set by the threshold pre-alarm value corresponding to that genset parameter, then the DP submodule will conclude that a pre-alarm condition exists. Additionally, each threshold alarm value may be accompanied by a programmable delay time, in which case the DP submodule will not conclude that an alarm condition exists until the received genset parameter remains outside the limit set by the threshold pre-alarm value for the duration of the delay time.

Moreover, it must be noted that a user can reprogram the threshold alarm values, threshold pre-alarm values, and delay times via the monitoring and control device's user interface software resident on a remote computer in communication with the monitoring device via the RS232 transceiver 152.

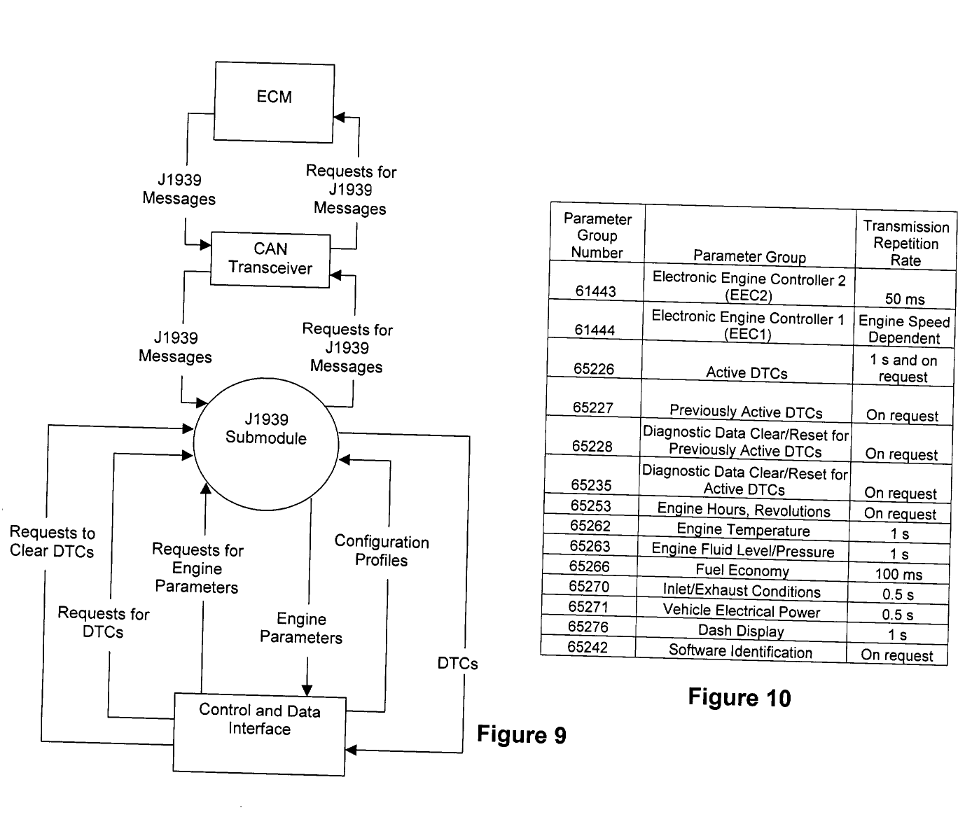

FIG. 9 illustrates how data flows between the CDI submodule 184, the J1939 submodule 186, CAN transceiver 154, and the engine CAN. Data flow can essentially be divided between inbound data (data coming from the engine's CAN bus to the monitoring and control device) and outbound data (data going to the engine's CAN bus from the monitoring and control device).

For inbound data, the engine's ECM transmits J1939 messages on the CAN bus that are received by the CAN transceiver 154 of the present invention. The CAN transceiver 154 will then pass the received J1939 messages to the J1939 submodule 186. The J1939 submodule 186 is configured to extract relevant engine data from the J1939 messages. The engine data contained in the J1939 messages may be values for various engine parameters or diagnostic trouble codes (DTCs)—either currently active DTCs or previously active DTCs. The extracted engine parameter values and DTCs are then passed to the CDI submodule 184. Once the extracted engine data is stored as variables in the CDI submodule, the data processing submodule 182 can read those variables and perform its processing tasks.

For outbound data, the data processing module 182 can initiate various requests to be sent to the ECM. These requests can be requests for various engine parameter values, requests for currently active and/or previously active DTCs, and requests to clear the DTCs stored by the ECM. The CDI submodule receives such requests from the data processing submodule and passes them on to the J1939 submodule. The J1939 submodule 186 then operates to packetize the received requests according to the J1939 protocol used by the generator so that a message frame containing a request can be understood and responded to appropriately by the engine's ECM. A request frame is similar in structure to the message frame of FIGS. 6(a) and 6(b), except the RTR bit will be low and the data field will be eliminated (for regular message frames, the RTR bit is high). The PGN for the request frame will identify the functional content being requested.

Further, it should be noted that not all engines will use identical J1939 messaging protocols. The particular messaging profile used by a particular engine that uses J1939 communications via a CAN may be slightly different than the particular messaging profile used by another type of engine. To account for such differences between the particular J1939 messaging profiles used by different engines, the present invention allows for the J1939 submodule 186 to be reconfigurable to match the particular J1939 messaging protocol used by the engine that the device is monitoring. To key the J1939 submodule 186 to the particular J1939 messaging profile used by the engine being monitored, the data processing module passes a configuration profile to the J1939 submodule 186 by way of the CDI submodule 184. The configuration profile will identify the particular message profile to use when processing J1939 data traffic. It should be noted that some engines do not currently support DTCs via the J1939 protocol. Those that do can send DTC information that relates to the proprietary elements of the engine (on a per manufacturer basis).

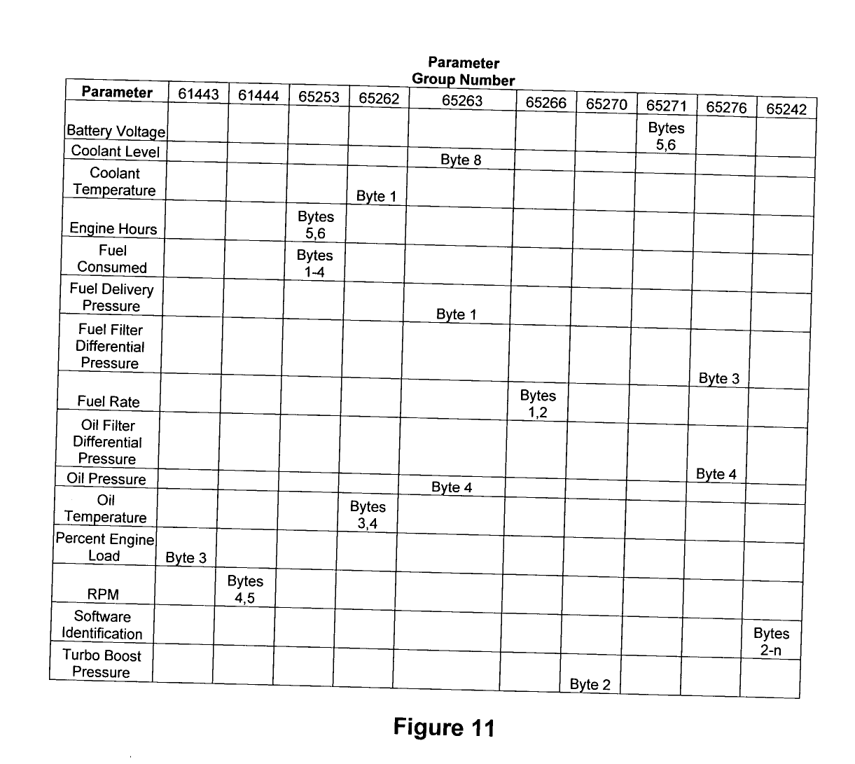

As stated above, J1939 messaging utilizes a 3 byte Parameter Group Number (PGN) to uniquely identify the functional content of each message. FIG. 10 is a table illustrating different PGNs used in ECM CAN broadcasts. FIG. 10 also identifies the functional content that corresponds to each PGN. Further, FIG. 11 identifies the particular engine data contained in particular bytes in the data field of a message having a particular PGN.

PGN 61,443 corresponds to the parameter group for electronic engine controller 2 (EEC2). As can be seen from FIG. 11, the engine parameter percent engine load can be found in byte 3 of a message having a PGN of 61,443. Also, as can be seen from FIG. 10, the ECM broadcasts messages having a PGN of 61,443 every 50 ms.

PGN 61,444 corresponds to the parameter group for electronic engine controller 1 (EEC 1). As can be seen from FIG. 11, the engine parameter revolutions per minute (RPM) can be found in bytes 4 and 5 of a message having a PGN of 61,444. Also, as can be seen from FIG. 10, the repetition with which messages having a PGN of 61,443 are broadcast is dependent on the engine speed of the generator.

PGN 65,226 corresponds to the parameter group for active DTCs. As long as there are any abnormal conditions present in the engine that warrant annunciation, the ECM broadcasts messages having a PGN of 65,226 every second. In the absence of any abnormal conditions, such a message is not periodically broadcast, but one can be transmitted upon request to update the active DTC information that may be maintained within the requesting device.

PGN 65,227 corresponds to the parameter group for previously active DTCs. PGN 65,228 corresponds to the parameter group for a clear/reset of the previously active DTC list, and PGN 65,235 corresponds to the parameter group for a clear/reset of the active DTC list. Messages for PGNs 65,227, 65,228, and 65,235 are all transmitted on request.

PGN 65,253 corresponds to the parameter group for engine hours. As can be seen from FIG. 11, the engine parameter engine operating hours can be found in bytes 1-4 of a message having a PGN of 65,253. Also, as can be seen from FIG. 10, the ECM broadcasts messages having a PGN of 65,253 on request.

PGN 65,262 corresponds to the parameter group for engine temperature. As can be seen from FIG. 11, the engine parameters coolant temperature (byte 1) and oil temperature (bytes 3, 4) can be found in a message having a PGN of 65,262. Also, as can be seen from FIG. 10, the ECM broadcasts messages having a PGN of 65,262 every second.

PGN 65,263 corresponds to the parameter group for engine fluid level and pressure. As can be seen from FIG. 11, the engine parameters coolant level (byte 8), fuel delivery pressure (byte 1), and oil pressure (byte 4) can be found in a message having a PGN of 65,263. Also, as can be seen from FIG. 10, the ECM broadcasts messages having a PGN of 65,263 every second.

PGN 65,266 corresponds to the parameter group for fuel economy. As can be seen from FIG. 11, the engine parameter fuel rate can be found in bytes 1 and 2 of a message having a PGN of 65,266. Also, as can be seen from FIG. 10, the ECM broadcasts messages having a PGN of 65,262 every 100 ms.

PGN 65,270 corresponds to the parameter group for inlet/outlet exhaust conditions. As can be seen from FIG. 11, the engine parameter turbo boost pressure can be found in byte 2 of a message having a PGN of 65,270. Also, as can be seen from FIG. 10, the ECM broadcasts messages having a PGN of 65,270 every 0.5 seconds.

PGN 65,271 corresponds to the parameter group for vehicle electrical power. As can be seen from FIG. 11, the engine parameter battery voltage can be found in bytes 5 and 6 of a message having a PGN of 65,271. Also, as can be seen from FIG. 10, the ECM broadcasts messages having a PGN of 65,271 every 0.5 seconds.

PGN 65,276 corresponds to the parameter group for dash display. As can be seen from FIG. 11, the engine parameters fuel consumed (byte 2, fuel filter differential pressure (byte 3), and oil filter differential pressure (byte 4) can be found in a message having a PGN of 65,276. Also, as can be seen from FIG. 10, the ECM broadcasts messages having a PGN of 65,276 every second.

PGN 65,242 corresponds to the parameter group for software identification. As can be seen from FIG. 11, the ECM parameter software identification can be found in bytes 2-n (wherein n is the last byte of the variable length message) of a message having a PGN of 65,242. Also, as can be seen from FIG. 10, the ECM broadcasts messages having a PGN of 65,242 on request.

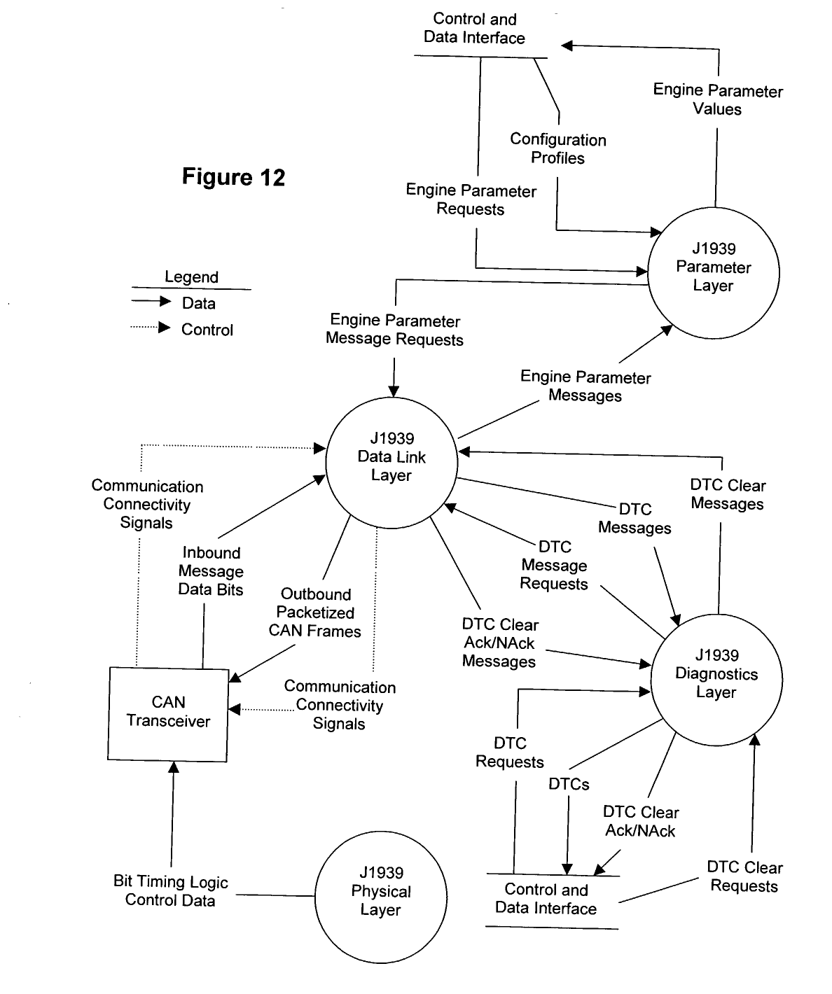

FIG. 12 illustrates a detailed diagram illustrating the data flow between the layers of the J1939 architecture as well as the interaction between the J1939 submodule and the CDI submodule. Once again, the data flow can be best characterized as having an inbound path component and an outbound path component.

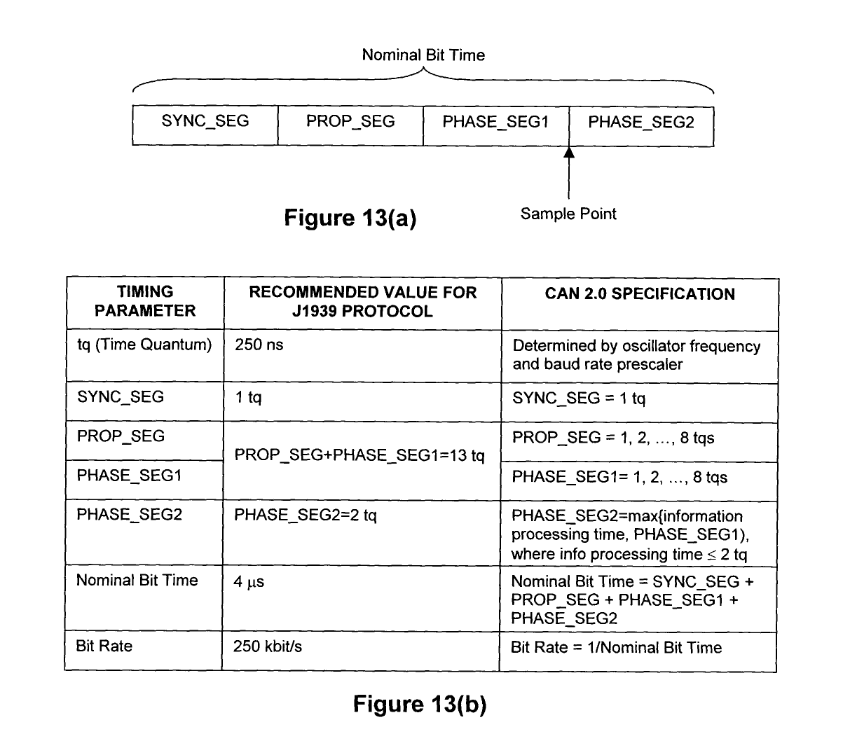

When processing incoming data, CAN transceiver 154 (which represents layers 2 and 3 of the J1939 5 layer model) receives J1939 messages. J1939 physical layer (layer 1) software programs the bit timing logic of the CAN transceiver with values for nominal bit time and sample point, as specified in FIGS. 13(a) and (b). As stated, each node on the CAN bus will receive each message placed on the CAN bus. Thus, each node will have to filter out messages in which it has no interest. CAN transceiver 154 is configured with acceptance masks and acceptance filters to filter out unwanted messages and pass wanted messages to the data link layer. Message filtration is judged from each frame's PGN. Message frames having a PGN of interest to the present invention are accepted while others are rejected. The data bits of accepted incoming messages are then passed by the CAN transceiver to the data link layer of the J1939 submodule. Additionally, the CAN transceiver will provide communication connectivity control signals to the data link layer that will allow the data link layer to delineate messages. Further, the CAN transceiver CAN bus monitoring to identify and correct any CAN bus errors that may arise during receive and/or transmit operations.

The data link layer operates to reassemble the incoming messages. After the incoming message is reassembled, its data length is validated, and data content identified, the data link layer passes the message to either the J1939 parameter processing layer or J1939 diagnostic processing layer depending upon whether the data content of the message contains engine parameter data or DTC data.

The parameter processing layer and diagnostic processing layer then operate to extract the pertinent data from the messages data field and pass the extracted data to the CDI submodule.

Outbound messages are initiated from the DP submodule. The DP submodule will either be programmed to periodically request particular engine parameters and/or DTC lists, or a user can initiate such requests via the user interface panel 144 and/or a remote device (through the RS232 communications port). These requests are provided to the CDI submodule, and the J1939 parameter/diagnostic layers then respond to those requests.

The J1939 parameter processing layer responds to a request for an engine parameter in the CDI submodule by passing a request to the data link layer for a message containing that engine parameter. Similarly, the J1939 diagnostic processing layer responds to a request for a list of DTCs or a request to clear DTCs by passing a request to the data link layer for a message satisfying the request.

The data link layer operates to receive such message requests from the parameter processing layer and diagnostics processing layer and generate outgoing CAN message frames formatted according to the J1939 protocol. The CAN/J1939 message frames are then passed to the CAN transceiver along with communication connectivity signals. The CAN transceiver performs bus arbitration to negotiate access to the CAN bus. Once the CAN transceiver gets control of the CAN bus, the outgoing message frame is broadcast thereon.

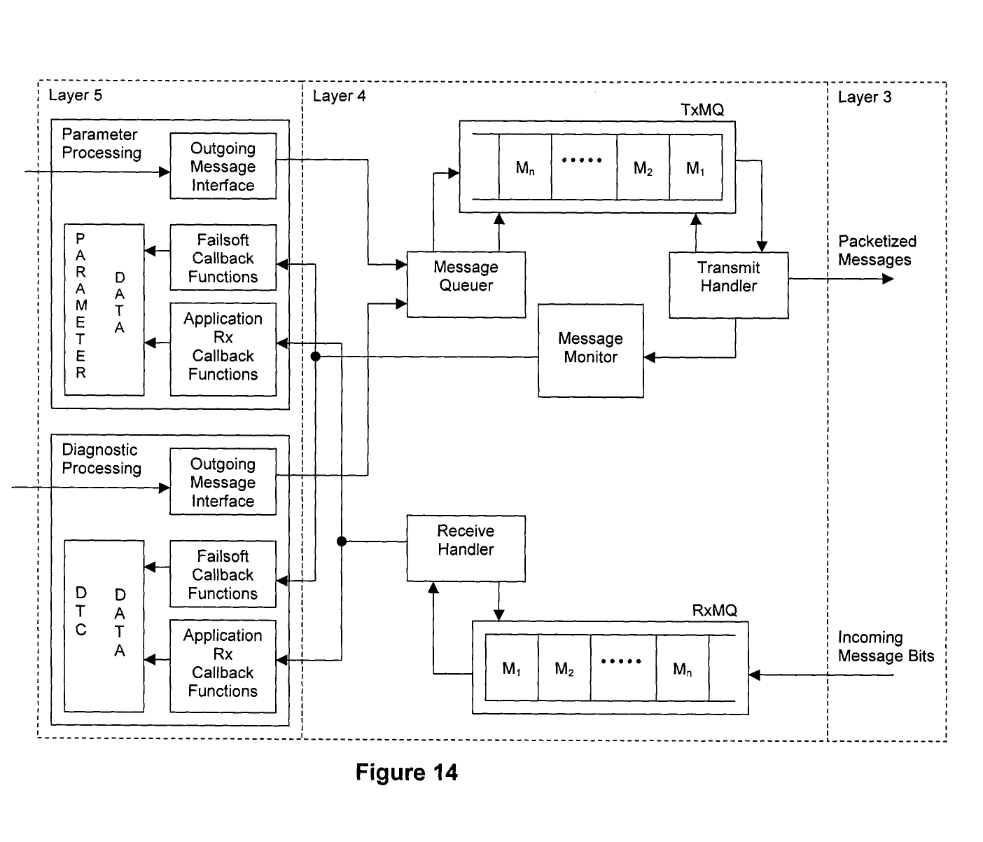

FIG. 14 illustrates how layers 4 and 5 of the J1939 submodule operate. When an operation is initiated to transmit a message via the CAN bus interface, the DP submodule will pass an appropriate request to the CDI submodule. The application layer (layer 5) of the J1939 submodule will then read the request out of the CDI submodule and place the request in an outgoing message interface. As noted from FIGS. 7 and 12, layer 5 of the J1939 submodule has two main components, engine parameter processing and diagnostic data processing. Engine parameter processing relates to processing performed in connection with the values for engine parameters found in J1939 messages broadcast on the CAN and diagnostic processing relates to processing performed in connection with the DTCs found in J1939 messages broadcast on the CAN. The particular outgoing message interface into which the outgoing message request is passed will depend on whether the outgoing message request relates to an engine parameter or engine diagnostic information.

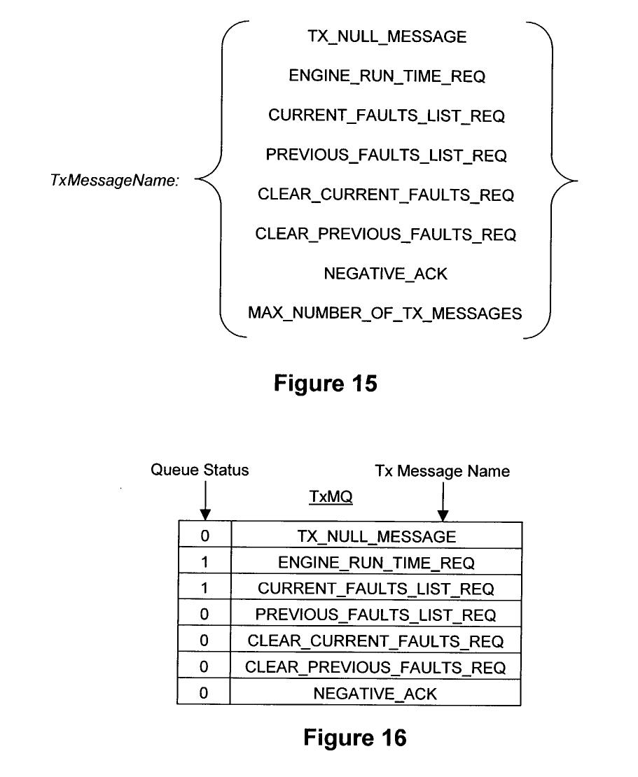

The message queuer in layer 4 of the J1939 submodule provides a QueueMessage(<message name>) function. The message queuer reads message names out of the outgoing message interfaces and queues those message names in the transmit message queue (TxMQ). The preferred embodiment of the present invention supports the transmission of 7 different functional messages by the monitoring and control device. The data array TxMessageName shown in FIG. 15 is populated with a list of the names of messages the device can transmit. These messages are Tx_Null_Message (which is simply the transmission of a blank message), Engine_Run_Time_Req (which corresponds to a request for engine data related to the operating time of the engine), Current_Faults_List_Req (which corresponds to a request for a list of currently active DTCs), Previous_Faults_List_Req (which corresponds to a request for a list of previously active DTCs), Clear_Current_Faults_Req (which corresponds to a request to clear the list of currently active DTCs), Clear_Previous_Faults_Req (which corresponds to a request to clear the list of previously active DTCs), and Negative_Ack (which corresponds to a negative acknowledgment). The parameter Max_Number_of_Tx_Messages included in the data structure TxMessageName is a constant used to determine the correct size of the transmit message queue. While it is preferable that the present invention supports the above-listed transmit messages, more or fewer transmit messages may be used, as would be readily apparent to one of ordinary skill in the art.

The order of the entries in the array TxMessageName correspond to the priorities of those message names relative to each other. Thus, the message name Tx_Null_Message has the highest priority, while the message name Negative_Ack has the lowest priority. A practitioner of the present invention is free to assign relative priorities to the different message names as he or she pleases.

TxMQ will include the message names in TxMessageName in the order they are found in TxMessageName. TxMQ will also include a bit associated with each message name in the list that identifies the queue status (either “queued” or “not queued”). FIG. 16 illustrates a preferred form of TxMQ. As the message queuer queues messages in TxMQ, it will assert the queue status bit accordingly. The message queuer preferably does not queue multiple instances of the same message. Thus, it is the responsibility of higher levels (e.g. layer 5) to determine for messages to be repeatedly queued in TxMQ when a message has been transmitted and a new copy of that message must be requeued. In the example of FIG. 16, it can be seen that the messages Engine_Run_Time_Req and Current_Faults_List_Req have been queued in TxMQ (by virtue of the queue status bit being asserted).

The Transmit Handler will scan TxMQ to identify a message for transmission. Transmit Handler will identify the message to be transmitted by identifying the highest priority message in TxMQ with its queue status bit set high. Preferably, the TransmitHandler function is invoked on a periodic basis (preferably on 5 ms intervals). However, practitioners of the present invention who wish to invoke TransmitHandler on an as-needed basis may do so if they desire, although modifications may be needed to integrate the as-needed TransmitHandler function with the overall operating system.

After the Transmit Handler has identified a message name for transmission, it then constructs a message corresponding to the identified message name. TransmitHandler will also reset the queue status of the dequeued message name to a queue status of “not queued”. To construct a message frame, the Transmit Handler must identify the characteristics of the dequeued message name.

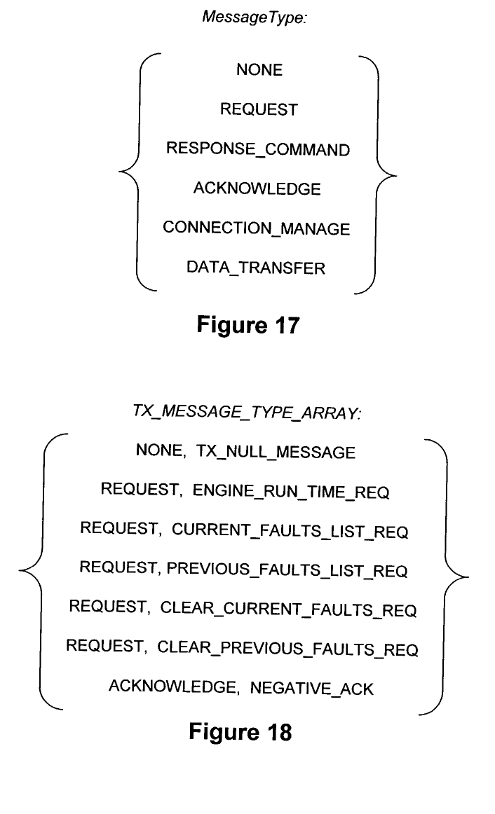

Each message name has a corresponding message type. J1939 utilizes 5 different types of messages: command messages (which command a specific action from a specific or global destination on the CAN), request messages (which provide the ability to request information globally or from a specific destination on the CAN), broadcast/response messages (which can be either an unsolicited broadcast of information from a device in communication with the CAN or a response to a command or request), acknowledgement messages (which is the response to a specific command or request), and group function messages (which relates to groups of special functions such as network management functions, multipacket transport functions, etc.). FIG. 17 is the data array MessageType for the present invention. It is populated with a list of message types used in connection with the present invention. The message types in the array of FIG. 17 are as follows: none (which is associated with null messages), request (as noted above), response_command (which corresponds to broadcast/response messages), acknowledge (as noted above), and connection_manage and data_transfer (which correspond to group functions).

FIG. 18 depicts the data structure TxMessageTypeArray. TxMessageTypeArray associates each message name identified in the array TxMessageName with a message type identified in the array TxMessageType. As can be seen from FIG. 18, Tx_Null_Message is of type None, the messages Engine_Run_Time_Req, Current_Faults_List_Req, Previous_Faults_List_Req, Clear_Current_Faults_Req, and Clear_Previous_Faults_Req are each of type Request, and Negative_Ack is of type Acknowledge. By consulting TxMessageTypeArray, the TransmitHandler can determine the appropriate message type for the message name it identifies for transmission.

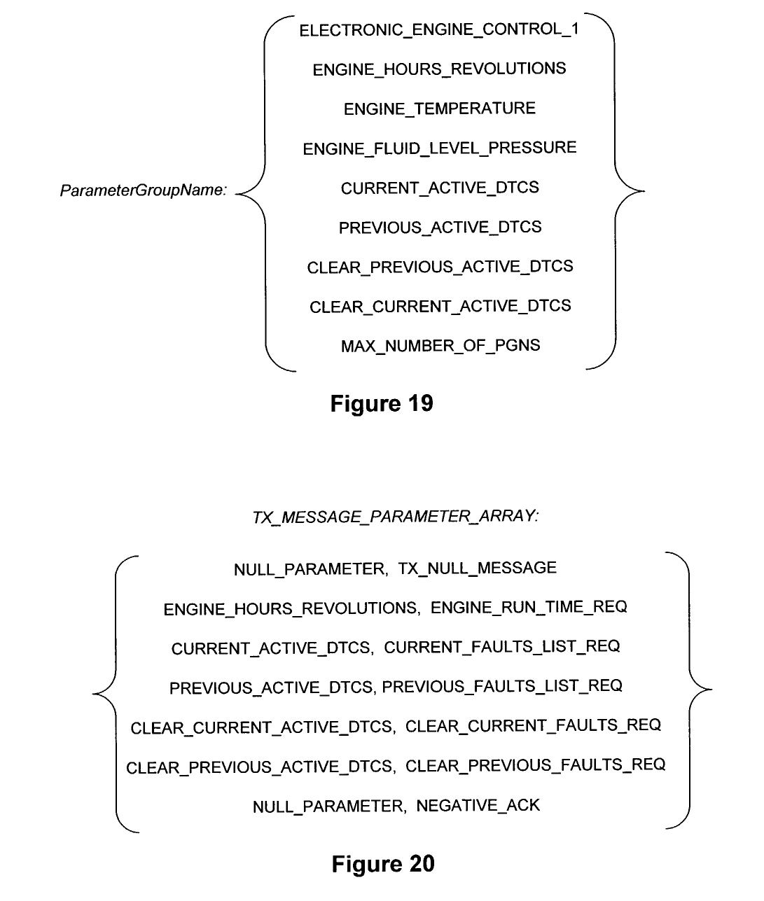

Another characteristic that Transmit Handler must identify for the message name is the particular parameter group that is associated with the message name. The arbitration field of the message frame will be set according to the parameter group. The data array ParameterGroupName shown in FIG. 19 lists the names for the parameter groups that are preferably supported by the present invention. Each name in ParameterGroupName corresponds to a message name in the array TxMessageName. The final listing in ParameterGroupName is Max_Number_of_PGNs which is a constant that is used to determine the correct size of the parameter descriptor table which is discussed below.

FIG. 20 depicts the data structure TxMessageParameterArray. TxMessageParameterArray associates each message name identified in the array TxMessageName with a parameter group name identified in the array ParameterGroupName. As can be seen from FIG. 20, Tx_Null_Message is associated with the parameter group Null_Parameter, the message Engine_Run_Time_Req is associated with the parameter group Engine_Hours, the messages Current_Faults_List_Req and Previous_Faults_List_Req are associated with the parameter groups Current_Active_DTCs and Previous_Active_DTCs respectively, the messages Clear_Current_Faults_Req, and Clear_Previous_Faults_Req are associated with the parameter groups Clear_Current_Active_DTCs and Clear_Previous_Active_DTCs respectively, and the message Negative_Ack is associated with the Null_Parameter. By consulting TxMessageParameterArray, the Transmit Handler identifies the particular parameter group name corresponding with the message to be transmitted.

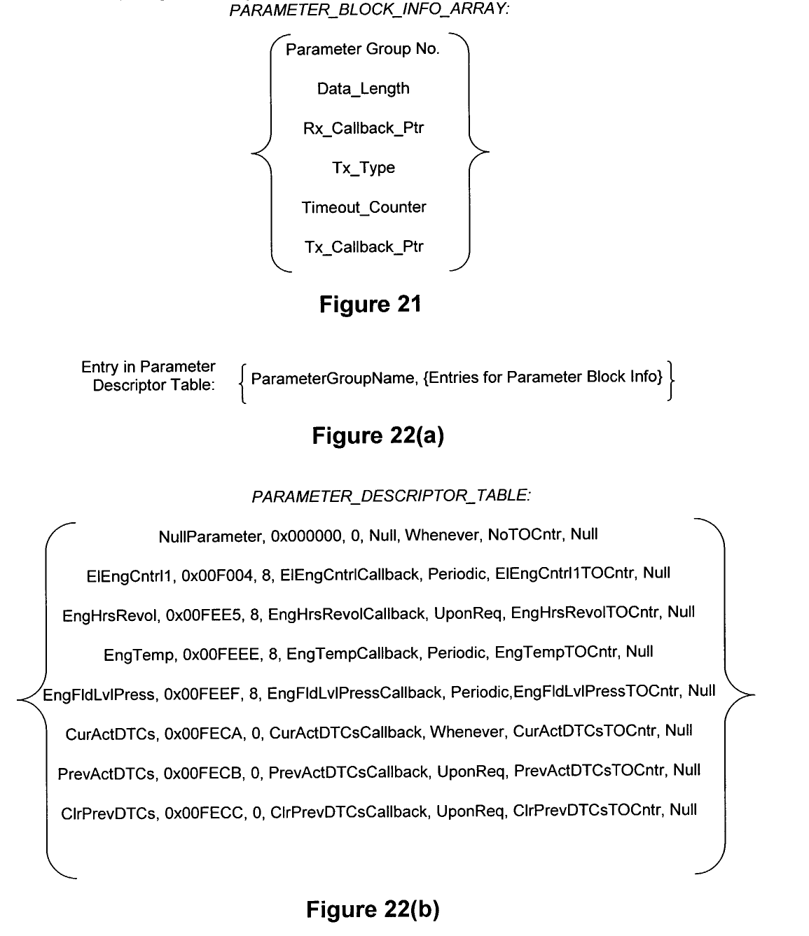

Each parameter group has a block of information associated therewith. FIG. 21, which depicts the data array ParameterBlockInfo, illustrates the information associated with each parameter group. The details of each entry in ParameterBlockInfo will be explained in more detail below. However, it should be noted that the first field in ParameterBlocklnfo identifies the parameter group number (PGN) that uniquely identifies the parameter group associated therewith. FIGS. 22(a) and 22(b) depict the ParameterDescriptorTable, which correlates each parameter group name with its related parameter block information fields. By consulting the ParameterDescriptorTable, the TransmitHandler can identify the PGN for the parameter to be included in the message.

Once the Transmit Handler identifies a message type and a PGN for the message name dequeued from TxMQ, it can construct the appropriate message frame suitable for transmission on the CAN. For example, if the message name dequeued from the TxMQ is Engine_Run_Time_Req, then the TransmitHandler will determine that a request message that requests the parameter Engine_Run_Time (PGN=65253) must be built. A message frame will be constructed wherein its PGN is set to 65253, its data field length is set to 0, and its RTR bit is set low. After the message is built, Transmit Handler will packetize the message into multiple frames if necessary (messages with data fields longer than 8 bytes will be broken down into separate message frames), and provide each message frame to layer 3 for subsequent transmission on the CAN bus. Further, the Transmit Handler will notify the Message Monitor of each request message it passes to layer 3. As will be explained in more detail below, the Message Monitor will determine whether a failsoft procedure should be invoked because too much time has passed since the transmission of a request without a response being received (thereby indicating that an error condition may exist).

Also, it should be noted that layer 4 can be defined such that the Message Queuer and TxMQ are not used. In situations where there is not enough outgoing traffic to justify the use of a queue for outgoing messages, the system can be configured such that outgoing message names are passed directly from layer 5 to the TransmitHandler.

The bits of incoming messages will be queued in the Receive Message Queue (RxMQ). The Receive Handler operates to reassemble each J1939 message frame from its constituent bits. Once a message is reassembled, the Receive Handler also validates the data length of the received message. If the length of the data field in the received message does not match the expected data length for the message, then the message is disregarded, and the Receive Handler invokes a failsoft procedure for the parameter associated with the PGN of the message frame to accommodate for the error. Also, when the PGN of the received message is identified, the Receive Handler can notify the Message Monitor accordingly, to thereby allow the Message Monitor to reset its Timeout Counter for the parameter associated with that PGN. Further still, the Receive Handler will invoke an application level callback routine for the message according to the message's PGN. The application level callback routine will operate to further process the message, including extract the pertinent engine data from the message. The Receive Handler performs these tasks by consulting various data arrays maintained by the system.

As noted above, the ParameterBlockInfo array of FIG. 21 identifies various characteristics associated with each parameter group. The first field in ParameterBlockinfo is the parameter group number (PGN).

The second field in ParameterBlockInfo is Data_Length. This field identifies the expected number of bytes in the data field of a message having the corresponding PGN. A zero is entered in this field if no data or variable length data is expected in the message. As noted above, the Receive Handler function uses this field to validate the data length of each received message.

The third field in ParameterBlockInfo is an Rx_Callback_Ptr. Rx_Callback_Ptr is a pointer to the routine that will process the body of the message in the application layer. Each parameter group will have an RxCallback function associated therewith. RxCallback functions will take two input variables: (1) the message type of the received message, and (2) a pointer to a 9 byte array that contains the data field of the received message frame (8 bytes) and the data length as the 9th byte. Each RxCallback function will operate to extract pertinent engine parameter values from the message's data field. The ECM will insert 255 into the data field of a message frame if the value for that parameter is in error. A Null is entered in the Rx_Callback_Ptr when no RxCallback function is associated with a particular parameter group.

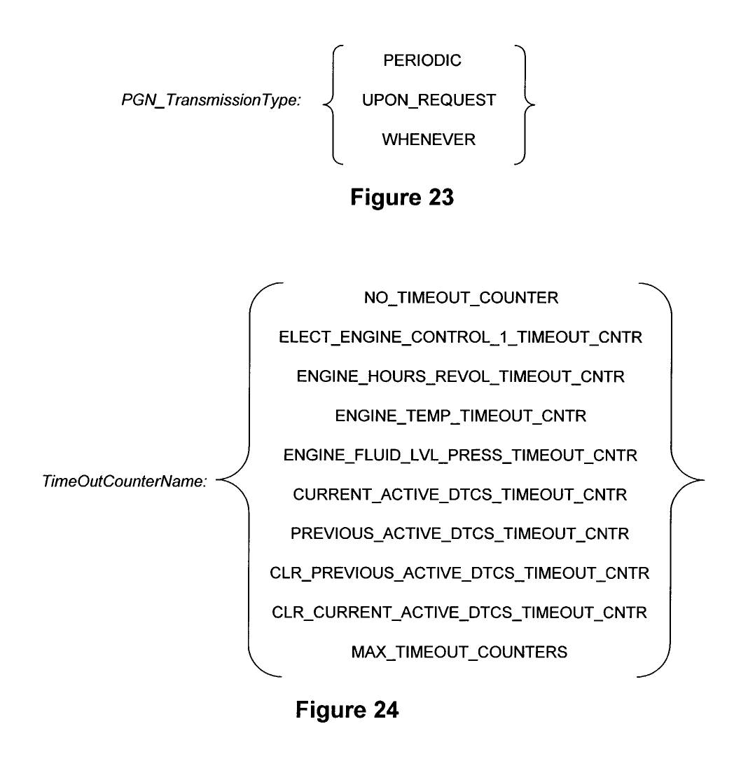

The fourth field in ParameterBlockInfo is Tx_Type. Tx_Type identifies how the ECM broadcasts messages with the corresponding parameter group. As shown in FIG. 23, the array PGNTransmissionType lists possible values for this field. The entries in PGNTransmissionType are Periodic (which identifies a transmission type for a parameter group that is periodically broadcast by the ECM over the CAN if the ECM transmits a parameter group both periodically and on request, then the periodic notation should be used), Upon_Request (which identifies a transmission type for a group that is only broadcast when the ECM receives a request for its transmission), and Whenever (which identifies a transmission type for a parameter group for which the J1939 submodule does not need to provide failsoft capability).

The fifth field in ParameterBlockInfo is Timeout_Counter. Timeout_Counter identifies the name of the particular timeout counter that is associated with a parameter group. If no timeout monitoring is needed for a message, then the value in Timeout_Counter should be No_Timeout_Counter. As will be explained below, the Message Monitor monitors the timeout counters for the various parameter groups to determine whether data that is expected has been received within an acceptable time limit.

The sixth field in ParameterBlockInfo is Tx_Callback_Ptr. Tx_Callback_Ptr is a pointer to the routine that builds the data portion of the corresponding Tx Message.

The ParameterDescriptorTable shown in FIG. 22(b) shows each engine parameter and its corresponding values for the fields in ParameterBlockInfo. Using the data in ParameterDescriptorTable, the Receive Handler (1) matches the PGN of the received message with a PGN in the table, (2) once the PGN is identified, validates the message's data length by comparing the data length of the received message with the data length field in the table, (3) consults the array MessageType of FIG. 23 to identify the message type for the received message, (4) invokes the appropriate RxCallback function by identifying the appropriate Rx_Callback_Ptr from the Parameter Descriptor Table and then passing the message's data field and message type as input to the RxCallback function, and (5) notifies the timeout counter identified in the table of the message's receipt.

As noted above, the Message Monitor provides failsoft capabilities. It does so by monitoring timeout counters that are associated with each of the parameter groups. If an expected message is not received within a configurable period of time, then the engine data associated with the parameter group of that expected message is assumed to have failed, and the current data for that parameter is no longer valid. A failsoft function error recovery function is invoked when such a condition exists. A failsoft action performed by a failsoft function may be as simple as assigning a default value to the engine data associated therewith, setting the new data value equal to the last known value, or disabling some operation until valid data is received. Also, more complicated error recovery techniques may be implemented.

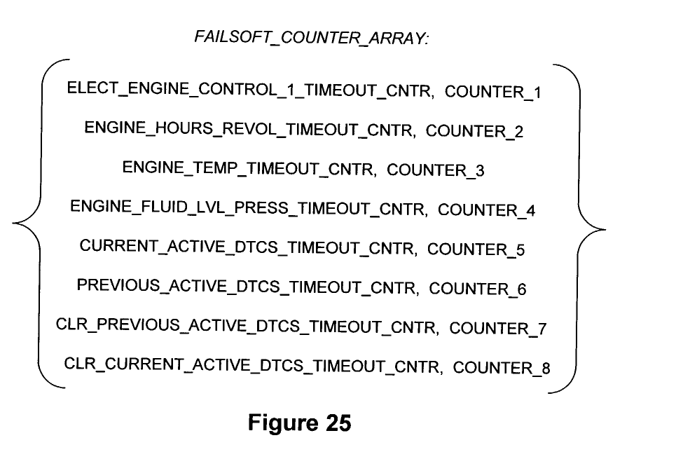

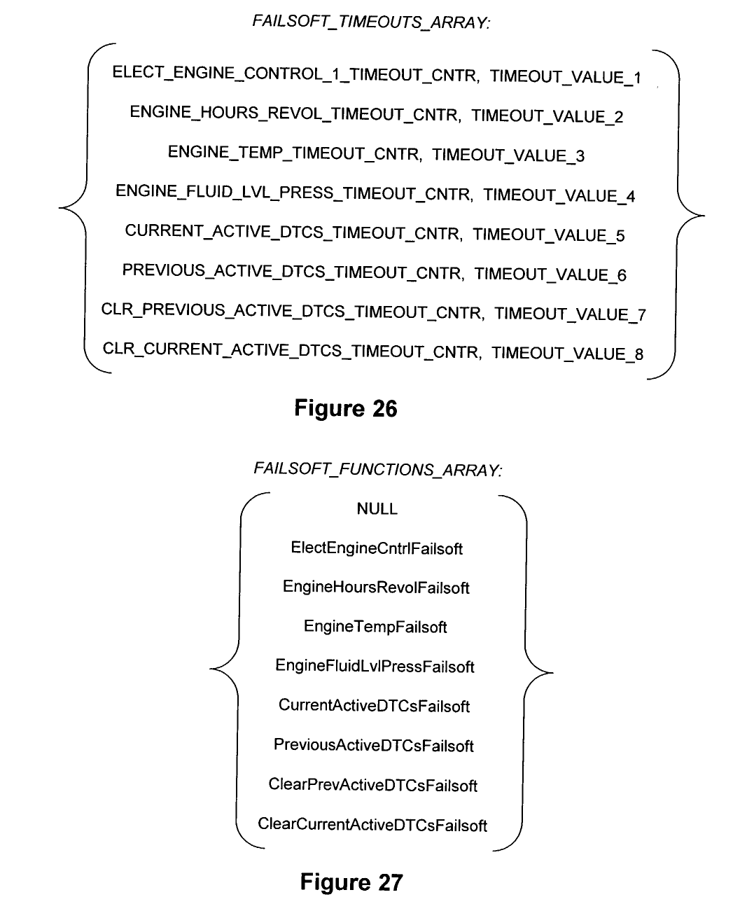

The array TimeOutCounterName is shown in FIG. 24. TimeOutCounterName is populated with the names of each timeout counter maintained by the J1939 submodule. The entries in this array are correlated to the various parameter groups in the ParameterDescriptorTable. The entry Max_Timeout_Counters is used to determine the correct size of the FailsoftCounterArray shown in FIG. 25. FailsoftCounterArray correlates each TimeOutCounterName with a particular counter maintained by the J1939 submodule. FailsoftTimeoutsArray shown in FIG. 26, correlates each entry in TimeoutCounterName with a timeout value. This timeout value identifies the counter value for which the Message Monitor determines that a failsoft condition exists. The value for Timeout_Value_through Timeout_Value_4, Timeout_Value_{—}7, and Timeout_Value_{—}8 is preferably 20; and the value for Timeout_Value_{—}5 and Timeout_Value_{—}6 is preferably 50. With the timeout resolution value set to 100 ms, these timeout values correspond to time lengths of 2 s and 5 s respectively.

Also, the FailsoftFunctionsArray shown in FIG. 27 correlates each entry in TimeoutCounterName with a pointer to a particular failsoft function to be invoked upon detection of a failsoft condition. Thus, when a particular message is identified by the Receive Handler or is flagged as “transmitted” by the Transmit Handler, an appropriate signal will be sent to the Message Monitor to reset the counter associated with the TimeoutCounterName for the message's parameter group. Thereafter, each counter is incremented as time passes. If a particular counter ever exceeds its associated timeout value, then the Message Monitor determines that a failsoft condition exists and invokes the failsoft callback routine identified in the FailsoftFunctionsArray for the timed-out parameter. Thus, if a periodic transmission of a message frame having a PGN=61444 (for the parameter Electronic_Engine_Control_{—}1) is expected, and more than 2 seconds have passed since the last message frame with a PGN=61444 (as determined from FailsoftTimeoutsArray) was received, then the Message Monitor will invoke ElectEngineCntrlFailsoft (as identified from FailsoftFunctionsArray). Also, by way of example, if a request for a list of currently active DTCs is transmitted by the Transmit Handler, the Message Monitor will reset the timeout counter for that parameter. If a response to the request is not received within 5 seconds, then the failsoft function for that parameter will be invoked.

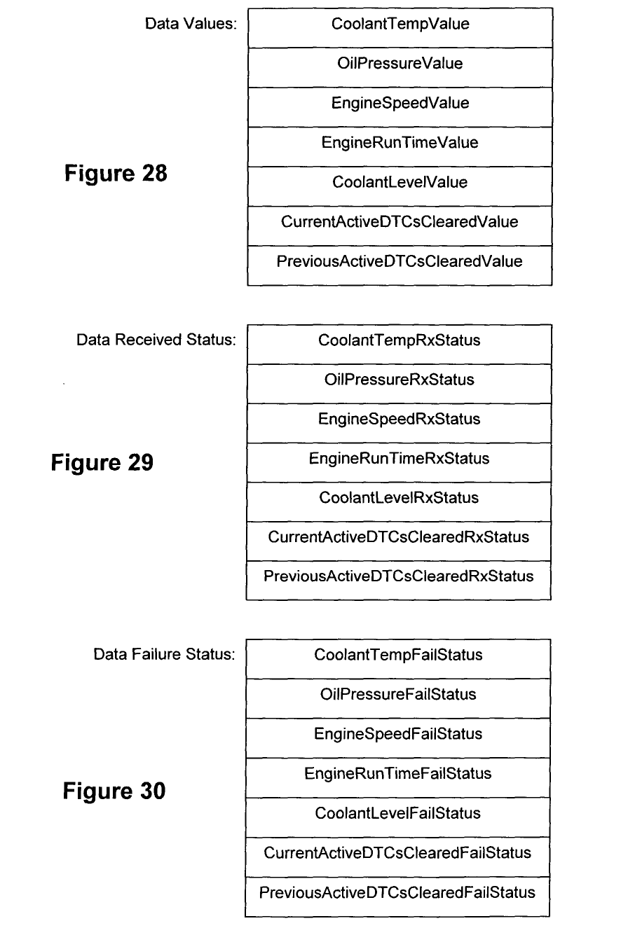

Each RxCallbackFunction and FailsoftFunction will post its results to a data structure that contains a value for the various values of extracted engine data, a data structure that identifies whether new data for a parameter value has been received, and a data structure that identifies whether a failure has occurred in obtaining a parameter value. FIGS. 28-30 show these data structures. The data structures shown in FIGS. 28-30 are passed to the CDI submodule. Once the data is stored in the CDI submodule, the DP submodule can receive and process the data to perform its monitoring tasks.

While the invention has been described above in relation to its preferred embodiment, various modifications may be made thereto that still fall within the invention's scope, as would be recognized by those of ordinary skill in the art. For example, while the processor used to process the data received by the CAN bus interface has been described wherein it is in direct communication with the CAN bus interface, the preferred embodiment may be modified such that the CAN bus interface communicates with the processor indirectly via a network such as the Internet, in which case the processor may be located remotely from the generator and may be implemented in a general purpose computer. Other networks, such as wireless networks, may also be used. These and other modifications to the preferred embodiment will be recognizable upon review of the teachings herein. As such, the scope of the present invention is to be defined by the appending claims in view of the description above and attached figures.

What is claimed is:

1. A device for monitoring and controlling a genset, said genset having an internal network over which engine data is communicated, said device comprising:
a network interface for coupling with said internal network to receive said engine data therefrom; and
a processor in communication with said network interface that is configured to process said received engine data to thereby control and monitor the operation of said genset.

2. The device of claim 1 wherein said internal network is a controller area network (CAN), wherein said CAN has a bus on which said engine data is communicated, and wherein said network interface is a CAN receiver for coupling with said CAN bus to receive said engine data therefrom.

3. The device of claim 2 wherein said engine data is communicated on said CAN bus as at least one message frame, and wherein said processor is programmed with a software module configured to (1) extract said engine data from said at least one message frame, and (2) process said extracted engine data to thereby control and monitor the operation of said genset.

4. The device of claim 3 wherein said at least one message frame is formatted according to a higher layer protocol (HLP), and wherein said software module is also configured to extract said engine data from said at least one message frame in accordance with said HLP.

5. The device of claim 4 wherein said HLP is a J1939 protocol.

6. The device of claim 5 wherein said engine data comprises a value for an engine parameter, said engine parameter being any of the group consisting of battery voltage, coolant level, coolant temperature, crank case pressure, operating hours, revolutions per minute (RPMs), turbo boost pressure, fuel consumption, fuel delivery pressure, fuel filter differential pressure, fuel consumption rate, oil filter differential pressure, oil pressure, oil temperature, and percent engine load.

7. The device of claim 6 wherein said engine data further comprises at least one diagnostic trouble code (DTC), each DTC being indicative of a problematic condition of said engine.

8. The device of claim 7 wherein said engine is configured to respond to a request for engine data by communicating said requested engine data on said CAN bus, wherein said CAN receiver is a CAN transceiver for coupling with said CAN bus to receive said engine data therefrom and transmit a request for engine data thereto, and wherein said processor is also configured to communicate a request for engine data to said CAN transceiver for subsequent transmission on said CAN bus.

9. The device of claim 8 further comprising a display in communication with said processor and at least one input in communication with said processor that is configured for a user to select at least a portion of said engine data to be displayed on said display, and wherein said software module is also configured to provide said selected engine data to said display for display thereon.

10. The device of claim 9 wherein said device input is also operable for a user to initiate a request for engine data, said software module also being configured to create at least one J1939 message frame that includes said engine data request and provide that at least one J1939 message frame to said CAN transceiver for transmission on said CAN bus.

11. The device of claim 10 wherein said engine data request is a request for at least one engine parameter value.

12. The device of claim 10 wherein said engine data request is a request for at least one currently active DTC.

13. The device of claim 10 wherein said engine data request is a request for at least one previously active DTC.

14. The device of claim 10 wherein said processor has a plurality of threshold alarm values stored therein, each threshold alarm value having a corresponding engine parameter, and wherein said software module is also configured to (1) determine whether an alarm condition exists by comparing an extracted value for an engine parameter with that engine parameter's corresponding stored threshold alarm value, and (2) if an alarm condition is determined to exist, provide a signal to said display that is operative to indicate the existence of said determined alarm condition.

15. The device of claim 14 wherein said processor has a plurality of threshold pre-alarm values stored therein, each threshold pre-alarm value having a corresponding engine parameter, and wherein said software module is also configured to (1) determine whether a pre-alarm condition exists by comparing an extracted value for a engine parameter with that engine parameter's corresponding stored threshold pre-alarm value, and (2) if a pre-alarm condition is determined to exist, provide a signal to said display that is operative to indicate the existence of said determined pre-alarm condition.

16. The device of claim 10 further comprising a communications device in communication with said processor that is configured to communicate at least a portion of said extracted engine data to a peripheral device.

17. The device of claim 16 wherein said extracted engine data of which at least a portion is communicated to said peripheral device is at least one DTC.

18. The device of claim 16 wherein said peripheral device is a computer having software stored thereon that is executable to (1) receive and process said extracted engine data communicated thereto by said communications device, said computer including a display for displaying at least a portion of said extracted engine data communicated thereto.

19. The device of claim 18 wherein said software stored on said computer is also executable to (1) receive and process a request for engine data from a user, and (2) communicate said engine data request to said processor by way of said communications device, said software module also being configured to create at least one J1939 message frame that includes said engine data request and provide that at least one J1939 message frame to said CAN transceiver for transmission on said CAN bus.

20. The device of claim 5 wherein said software module is configurable to process a message frame formatted in any of a plurality of message profiles for said J1939 protocol.

21. The device of claim 6 wherein said software module is also configured to invoke a failsoft function for an engine parameter in the event that a message frame for that engine parameter is not received within a configurable interval of time, said failsoft function being operable to set a value for that engine parameter.

22. A method of controlling and monitoring the operation of a genset, said genset having an internal network over which engine data is transmitted, said engine data being indicative of how said genset is operating, said method comprising:
interfacing with said internal network of said genset;
receiving engine data transmitted on said internal network; and
processing said received engine data to thereby control and monitor the
operation of said genset.

23. The method of claim 22 wherein said internal network is a controller area network (CAN) having a CAN bus on which said engine data is transmitted, and wherein said interfacing step includes interfacing with said CAN bus.

24. The method of claim 23 wherein said receiving step includes receiving a value for an engine parameter, said engine parameter being a member of the group consisting of battery voltage, coolant level, coolant temperature, crank case pressure, operating hours, revolutions per minute (RPMs), turbo boost pressure, fuel consumption, fuel delivery pressure, fuel filter differential pressure, fuel consumption rate, oil filter differential pressure, oil pressure, oil temperature, and percent engine load.

25. The method of claim 24 wherein said receiving step includes receiving a diagnostic trouble code (DTC), said DTC being indicative of a problematic condition of said engine.

26. The method of claim 25 wherein said DTC receiving step includes receiving a list of currently active DTCs.

27. The method of claim 26 wherein said DTC receiving step also includes receiving a list of previously active DTCs.

28. The method of claim 27 wherein said engine data is transmitted on said CAN bus as at least one message frame formatted in a J1939 protocol, and wherein said processing step includes extracting said engine data from said at least one J1939 message frame.

29. The method of claim 28 wherein said processing step further includes:
retrieving a stored threshold alarm value that corresponds to an engine parameter; and
determining whether an alarm condition exists by comparing said stored threshold alarm value for a particular engine parameter with that engine parameter's value that is extracted from a J1939 message frame.

30. The method of claim 29 wherein said processing step further includes:
retrieving a stored threshold pre-alarm value that corresponds to an engine parameter; and
determining whether a pre-alarm condition exists by comparing said stored threshold pre-alarm value for a particular engine parameter with that engine parameter's value that is extracted from a J1939 message frame.

31. The method of claim 28 wherein said processing step further includes:
receiving input from a user that corresponds to a selection of a particular engine parameter value for display; and
displaying said selected engine parameter value on a display.

32. The method of claim 31 wherein said processing step further includes:
receiving input from a user that corresponds to a selection of a currently active DTC for display; and
displaying said selected currently active DTC on a display.

33. The method of claim 32 wherein said processing step further includes:
receiving input from a user that corresponds to a selection of a previously active DTC for display; and
displaying said selected previously active DTC on a display.

34. The method of claim 28 further comprising:
receiving input from a user that corresponds to a request for engine data;
formatting said engine data request according to said J1939 protocol to thereby create a J1939 request message frame
transmitting said request message frame on said CAN bus; and
receiving said requested engine data via said CAN bus.

35. The method of claim 34 wherein said engine data request is a request for a value of an engine parameter.

36. The method of claim 34 wherein said engine data request is a request for a list of currently active DTCs.

37. The method of claim 34 wherein said engine data request is a request for a list of previously active DTCs.

38. The method of claim 28 wherein said engine data is transmitted on said CAN bus as at least one message frame formatted in any of a plurality of messaging profiles for said J1939 protocol, and wherein said processing step further includes selecting a configuration profile that identifies said J1939 protocol messaging profile used by said engine and extracting said engine data from said at least one J1939 message frame in accordance with said selected configuration profile.

39. The method of claim 28 further comprising:
interfacing with a peripheral device; and
communicating at least a portion of said extracted engine data to said peripheral device.

40. The method of claim 39 wherein said extracted engine data of which at least a portion is communicated to said peripheral device is at least one DTC.

41. The method of claim 39 further comprising:
receiving input from said peripheral device that corresponds to a request for engine data;
transmitting said request for engine data on said CAN bus; and
receiving said requested engine data via said CAN bus.

42. The method of claim 28 further comprising:
receiving input from a user that corresponds to a request to clear at least one of the group consisting of said list of currently active DTCs and said list of previously active DTCs;
formatting said DTC clear request according to said J1939 protocol to thereby create a J1939 request message frame;
transmitting said request message frame on said CAN bus.

43. The method of claim 28 further comprising:
tracking an amount of time between receipt of successive message frames for a particular engine parameter; and
performing a failsoft function for that particular engine parameter if the amount off time between receipt of successive message frames for that particular engine parameter exceeds a configurable threshold value.

44. A device for coupling with, and controlling and monitoring a genset, said genset having an engine control module (ECM) that transmits a plurality of message frames on a controller area network (CAN) bus, said message frames being formatted according to a J1939 protocol and containing engine data therein, said engine data being indicative of how said engine is operating, said device comprising:
a CAN bus interface for coupling with said CAN bus and configured to receive said message frames transmitted thereon; and
a processor in communication with said CAN bus interface and configured to extract said engine data from said received message frames and process said extracted engine data to thereby monitor said engine.

45. The device of claim 44 wherein said ECM is also responsive to a request for engine data by transmitting at least one message frame that contains said requested engine data on said CAN bus, wherein said processor is further configured to (1) receive input from a user that corresponds to a request for engine data, (2) convert said received engine data request into a J1939 message frame that contains said engine data request, and (3) provide that J1939 message frame to said CAN bus interface for transmission on said CAN bus, and wherein said CAN bus interface is also configured to transmit a J1939 message frame that contains a request for engine data on said CAN bus.

46. The device of claim 45 wherein said engine data comprises at least one value for at least one engine parameter, each engine parameter being a member of the group consisting of battery voltage, coolant level, coolant temperature, crank case pressure, engine operating hours, revolutions per minute (RPMs), turbo boost pressure, fuel consumption, fuel delivery pressure, fuel filter differential pressure, fuel consumption rate, oil filter differential pressure, oil pressure, oil temperature, and percent engine load.

47. The device of claim 45 wherein said engine data comprises at least one diagnostic trouble code (DTC), said DTC being indicative of a problematic condition of said engine.

48. The device of claim 47 wherein said engine data comprises a list of currently active DTCs.

49. The device of claim 47 wherein said engine data comprises a list of previously active DTCs.

50. A system for controlling and monitoring the operation of a genset, said system comprising:
an engine having an internal network over which engine data is broadcast;
a genset monitoring and control device for coupling with said internal network to receive said engine data broadcast thereon and processing said received engine data to thereby monitor the operation of said genset.

51. The system of claim 50 wherein said internal network is a controller area network (CAN), said CAN having a bus on which said genset monitoring and control device comprises a CAN bus interface for coupling with said CAN bus to receive said engine data and a processor in communication with said CAN bus for processing said received engine data to thereby monitor the operation of said genset.

52. The system of claim 51 wherein said engine data is broadcast on said CAN bus as a plurality of CAN message frames formatted according to a J1939 protocol, and wherein said processor is further configured to extract said engine data from said message frames.

53. The system of claim 52 wherein said genset monitoring and control device is further configured to transmit a message frame on said CAN bus containing a request for engine data from said genset.

54. A device for interactively monitoring and operating at least one genset, said at least one genset having an internal network over which engine data is communicated to and from an ECM, said ECM being associated with it's own genset, said device comprising:
a network interface for coupling with said internal network to receive said engine data and to transmit commands thereover to and receive engine data from said ECM; and
a processor in communication with said network interface, said processor being configured to process received engine data to thereby monitor the operation of said genset and transmit commands to said ECM for collection of engine data and control of genset operation.

55. The device of claim 54 wherein said device further comprises a remote connection port, said remote connection port being configured to support transmissions of data and commands between said device and a remote controller.

56. The device of claim 55 wherein said remote controller comprises a PC, said PC being programmed to control the device and thereby permit remote interactive monitoring and control of said at least one genset.

57. The device of claim 56 wherein said internal network is a controller area network (CAN), wherein said CAN has a bus on which said engine data and commands are communicated, and wherein said network interface is a CAN receiver for coupling with said CAN bus to receive said engine data therefrom.

58. A method of interactively monitoring and controlling the operation of a genset, said genset having an internal network over which engine data and commands are transmitted, said engine data being indicative of how said genset is operating and said commands being for operation of said genset, said method comprising:
interfacing with said internal network of said genset;
receiving engine data transmitted on said internal network;
transmitting requests for engine data over said internal network; and
processing said received engine data to thereby monitor and control the operation of said genset.

59. The method of claim 58 further comprising providing a remotely located PC, said PC being programmed to connect to and operate said device.

60. The method of claim 59 wherein the step of transmitting commands includes transmitting commands to start up and run said genset.

61. The method of claim 58 wherein said internal network is a controller area network (CAN) having a CAN bus on which said engine data is transmitted, and wherein said interfacing step includes interfacing with said CAN bus.

62. The method of claim 61 wherein said genset includes an ECM, and wherein said commands include powering on said ECM to thereby collect data.

63. The method of claim 62 wherein said outputs include starting and running the genset.

64. The method of claim 62 further comprising providing a remotely located PC, said PC being programmed to connect to and operate said device.

65. A device for interactively monitoring and controlling a genset, said genset having an ECM networked therewith via a CAN bus, said device including a processor connected to the CAN bus, said processor having a remote communications port for transmitting and receiving data from a remote PC, said PC being programmed to operate the device and thereby provide for remote control and monitoring of said genset, said device being configured to power up said ECM to thereby operate said genset and demand data collection.

66. The device of claim 65 wherein said ECM produces engine data corresponding to engine parameter values, and wherein said device is configured to process said engine data and perform actions in response thereto.
